(19) United States
(12) Patent Application Publication
(10) Pub. No.: US 2026/0095902 A1
(43) Pub. Date: Apr. 2, 2026

(54) BEAMS WITH DIFFERENT SPATIAL DOMAIN PROPERTIES

(71) Applicant: Lenovo (United States) Inc., Morrisville, NC (US)

(72) Inventors: Sher Ali Cheema, Ilmenau (DE); Ahmed Hindy, Aurora, IL (US)

(73) Assignee: Lenovo (United States) Inc., Morrisville, NC (US)

(21) Appl. No.: 18/905,028

(22) Filed: Oct. 2, 2024

(51) Int. Cl. H04W 72/044; H04B 7/06; H04W 74/0833

(52) U.S. Cl. CPC H04W 72/046; H04B 7/0626; H04W 74/0833

(57) ABSTRACT

Various aspects of the present disclosure relate to beams with different spatial domain properties. An apparatus, such as a user equipment (UE), receives a first downlink beam and transmits at least one uplink signal based at least in part on the first downlink beam. The UE receives a second downlink beam based at least in part on the first downlink beam, wherein the second downlink beam includes at least one different spatial domain property than the first downlink beam.

### TECHNICAL FIELD

The present disclosure relates to wireless communications, and more specifically to beam management (e.g., identification, selection, refinement) in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to receive a first downlink beam; transmit at least one uplink signal based at least in part on the first downlink beam; and receive a second downlink beam based at least in part on the first downlink beam, wherein the second downlink beam includes at least one different spatial domain property than the first downlink beam.

In some implementations of the method and apparatuses for a UE described herein, the at least one uplink signal includes one or more of a physical random access channel (PRACH) transmission or a sounding reference signal (SRS) transmission; the second downlink beam includes one or more of demodulation reference signal (DMRS) for physical downlink shared channel (PDSCH), tracking reference signal (TRS), or channel state information reference signal (CSI-RS); one or more of a coverage area, a beam width, or a beam footprint associated with the first downlink beam is larger than one or more of a coverage area, a beam width, or a beam footprint associated with the second downlink beam; the at least one processor is configured to cause the UE to receive a configuration for the at least one uplink signal, wherein the configuration includes parameters for performing an extended PRACH transmission by transmitting multiple uplink signals; the parameters include a repetition factor and PRACH duration for determining a duration and resources for the extended PRACH transmission of uplink signals; the at least one processor is configured to cause the UE to determine the duration for the extended PRACH transmission of uplink signals based at least in part on multiplying the PRACH duration with the repetition factor.

In some implementations of the method and apparatuses for a UE described herein, the at least one processor is configured to cause the UE to transmit multiple uplink signals corresponding to the repetition factor using spatial domain properties of the first downlink beam; the extended PRACH transmission includes consecutive time domain symbols of slots that are determined by extending a number of PRACH symbols by the repetition factor; the at least one processor is configured to cause the UE to: receive the first downlink beam at a first occasion and perform an initial access procedure based at least in part on the first downlink beam; receive a SRS configuration for beam refinement; receive the first downlink beam at a second occasion and transmit a SRS burst based at least in part on the SRS configuration; and receive the second downlink beam based at least in part on the SRS burst; the SRS configuration for beam refinement includes at least a repetition factor defining a length of the SRS burst; the at least one processor is configured to cause the UE to receive an indication that the repetition factor is within a slot or across slots; the at least one processor is configured to cause the UE to receive an indication to use one or more spatial domain properties of the first downlink beam for multiple SRS repetitions.

Some implementations of the method and apparatuses described herein may further include a processor for wireless communication to receive a first downlink beam; transmit at least one uplink signal based at least in part on the first downlink beam; and receive a second downlink beam based at least in part on the first downlink beam, wherein the second downlink beam includes at least one different spatial domain property than the first downlink beam.

Some implementations of the method and apparatuses described herein may further include a method performed by a UE, the method including receiving a first downlink beam; transmitting at least one uplink signal based at least in part on the first downlink beam; and receiving a second downlink beam based at least in part on the first downlink beam, wherein the second downlink beam includes at least one different spatial domain property than the first downlink beam.

In some implementations of the method and apparatuses for a UE described herein, the at least one uplink signal includes one or more of a PRACH transmission or a SRS transmission; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; further including receiving a configuration for the at least one uplink signal, wherein the configuration includes parameters for performing an extended PRACH transmission by transmitting multiple uplink signals; the parameters include a repetition factor and PRACH duration for determining a duration and resources for the extended PRACH transmission of uplink signals; further including determining the duration for the extended PRACH transmission of uplink signals based at least in part on multiplying the PRACH duration with the repetition factor.

In some implementations of the method and apparatuses for a UE described herein, further including transmitting multiple uplink signals corresponding to the repetition factor using spatial domain properties of the first downlink beam; the extended PRACH transmission includes consecutive time domain symbols of slots that are determined by extending a number of PRACH symbols by the repetition factor; further including: receiving the first downlink beam at a first occasion and perform an initial access procedure based at least in part on the first downlink beam; receiving a SRS configuration for beam refinement; receiving the first downlink beam at a second occasion and transmit a SRS burst based at least in part on the SRS configuration; and receive the second downlink beam based at least in part on the SRS burst; the SRS configuration for beam refinement includes at least a repetition factor defining a length of the SRS burst; further including receiving an indication that the repetition factor is within a slot or across slots; further including receiving an indication to use one or more spatial domain properties of the first downlink beam for multiple SRS repetitions.

Some implementations of the method and apparatuses described herein may further include a NE for wireless communication to transmit a first downlink beam; receive at least one uplink signal based at least in part on the first downlink beam; and transmit a second downlink beam based at least in part on the first downlink beam, wherein the second downlink beam includes at least one different spatial domain property than the first downlink beam.

In some implementations of the method and apparatuses for a NE described herein, the at least one uplink signal includes one or more of a PRACH transmission or a SRS transmission; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; the at least one processor is configured to cause the NE to transmit a configuration for the at least one uplink signal, wherein the configuration includes parameters for performing an extended PRACH transmission by transmitting multiple uplink signals.

Some implementations of the method and apparatuses described herein may further include a method performed by a NE, the method including transmitting a first downlink beam; receiving at least one uplink signal based at least in part on the first downlink beam; and transmitting a second downlink beam based at least in part on the first downlink beam, wherein the second downlink beam includes at least one different spatial domain property than the first downlink beam.

In some implementations of the method and apparatuses for a NE described herein, the at least one uplink signal includes one or more of a PRACH transmission or a SRS transmission; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; transmitting a configuration for the at least one uplink signal, wherein the configuration includes parameters for performing an extended PRACH transmission by transmitting multiple uplink signals.

### BRIEF DESCRIPTION OF THE DRAWINGS

FIG. 1 illustrates an example of a wireless communications system in accordance with aspects of the present disclosure.

FIG. 2 and FIG. 3 illustrate cell mapping scenarios in an non-terrestrial network (NTN).

FIG. 4 illustrates Frequency Reuse Factor (FRF) scenarios in an NTN.

FIG. 5 illustrates an example implementation scenario where multiple beams are in a cell and each beam is mapped to a bandwidth part (BWP).

FIGS. 6-8 illustrate an example information element for discontinuous reception (DRX) configuration.

FIG. 9 illustrates an example for extended physical random access channel (PRACH) duration in accordance with aspects of the present disclosure.

FIG. 10 illustrates an example scenario where individual beams groups are associated with information blocks of a DCI in accordance with aspects of the present disclosure.

FIG. 11 and FIG. 12 illustrate example timelines of receiving SSB beam groups and corresponding DL signaling in accordance with aspects of the present disclosure.

FIG. 13 illustrates an example of a UE in accordance with aspects of the present disclosure.

FIG. 14 illustrates an example of a processor in accordance with aspects of the present disclosure.

FIG. 15 illustrates an example of a NE in accordance with aspects of the present disclosure.

FIG. 16 illustrates a flowchart of a method in accordance with aspects of the present disclosure.

FIG. 17 illustrates a flowchart of a method in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. As part of improving usage of time-frequency resources, beam management assists in improving signal directivity to increase coverage and capacity. In NTN deployments, satellites are several hundred to several thousand kilometers away from ground UEs, and hence the role of beamforming becomes more critical. For instance, the number of beams spanning the coverage area is significantly larger than terrestrial network (TN) deployments, and hence the power consumed on beam management as well as the beam acquisition time is significantly larger. This issue becomes more critical as new low-cost non-geostationary orbit (NGSO) satellites are power limited as compared to TN-based stations, and thus distributing the limited satellite on-board power to a large number of beams can reduce the link budget significantly. Furthermore, for a NGSO system, the beam dwelling time (e.g., the time over which the strongest beam per UE is expected to change) is short, leading to the need for beam update procedures.

Aspects of the present disclosure are described in the context of a wireless communications system, and include implementations that provide an enhanced beam management framework (e.g., for NTN deployments) that enables hopping from one beam to another beam over different occasions associated with DL beam signaling. For instance, implementations provide for grouping of a set of beams into a plurality of beam groups according to at least one of an activation behavior and deactivation behavior of a beam. Further, additional uplink (UL) and DL signaling can refine a beam in the set of beams to a narrower beam for DL-dedicated signaling to improve performance. Implementations also provide procedures and configuration aspects for beam refinement (e.g., transitioning from wider to narrower beams) during initial access (e.g., for Msg 2) or a connected mode. In such implementations, a sounding reference signal (SRS) burst can be used to identify a best (e.g., highest quality) narrow beam. Further, an extended physical random access channel (PRACH) transmission can be applied for beam refinement of random access message transmissions (e.g., Msg 2) or in a connected mode. Implementations also provide a new DCI (also referred to as DCI signaling) that enables switching of a beam hopping scheme (also referred to as a beam hopping pattern) based on one or more factors, including DL traffic, coverage area, and capacity. Further, a beam hopping scheme can be associated with a cell DTX scheme that is enabled or disabled for a subset of periods of the beam hopping scheme.

By performing the described techniques, devices in a wireless communications system can increase signal quality and decrease power usage, such as in beam management scenarios.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

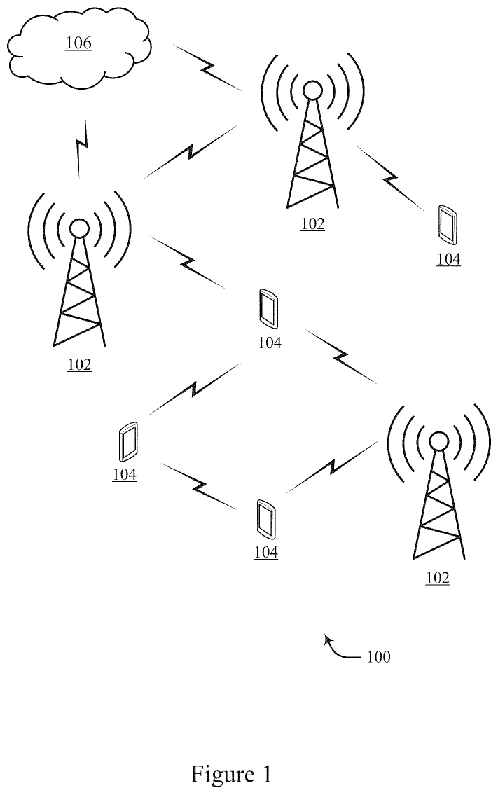

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 KHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives (e.g., obtains, retrieves) a first downlink beam (e.g., first downlink beamformed transmission), transmits at least one uplink signal (e.g., uplink transmission) based at least in part on the first downlink beam, and receives a second downlink beam (e.g., second downlink beamformed transmission) based at least in part on the first downlink beam, wherein the second downlink beam includes at least one different spatial domain property than the first downlink beam.

An NE 102 (e.g., a satellite, a base station, gNB) transmits (e.g., sends, communicates signals, outputs) a first downlink beam (e.g., first downlink beamformed transmission), receives at least one uplink signal (e.g., uplink transmission) based at least in part on the first downlink beam, and transmits a second downlink beam (e.g., second downlink beamformed transmission) based at least in part on the first downlink beam, wherein the second downlink beam includes at least one different spatial domain property than the first downlink beam. In implementations, the term “transmission” refers to a signal that is not steered and is transmitted or received on a resource mapped to a downlink and/or uplink direction in a downlink and/or uplink phase. In contrast, a “beamformed transmission” refers to a signal transmitted over a beam that is directed in a specific direction.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

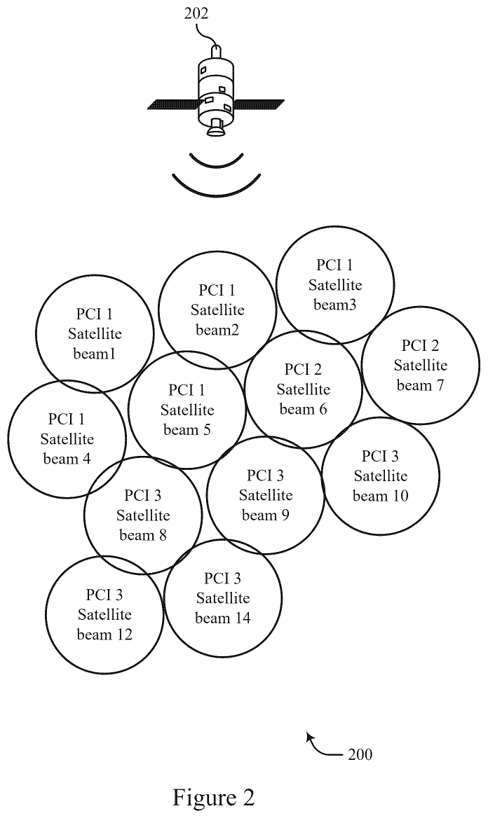

FIG. 2 illustrates a cell mapping scenario 200 in an NTN. In the example of FIG. 2, a satellite 202 may be configured to or operable to support a set of beams (also referred to as satellite beams) for wireless communication (e.g., for downlink and/or uplink communication). For example, a beam may carry one or more synchronization signal blocks (SSBs). In some cases, a beam may be referred to as an SSB beam. Each SSB can be transmitted and received in a specific direction using a beam. Multiple beams may be used by the satellite 202 to cover different coverage areas. The satellite 202 may be an example of NE as described herein. One or more subset of beams of the set of beams of the satellite 202 may be associated with a same cell (i.e., a same physical cell identity (PCI) for each beam of the subset of beams). For example, a first satellite beam may be associated with a first PCI (PCI 1), a second satellite beam may be associated with the PCI 1, a third satellite beam may be associated with the PCI 1, a fourth satellite beam may be associated with the PCI 1, a fifth satellite beam may be associated with the PCI 1. Additionally, or alternatively, a sixth satellite beam may be associated with a second PCI (PCI 2) and a seventh satellite beam may be associated with the PCI 2. Additionally, or alternatively, an eighth satellite beam may be associated with a third PCI (PCI 3), a nineth satellite beam may be associated with the PCI 3, a tenth satellite beam may be associated with the PCI 3, an eleventh satellite beam may be associated with the PCI 3, a thirteenth satellite beam may be associated with the PCI 3, and a fourteenth satellite beam may be associated with the PCI 3. It should be understood that the numbering of PCI provided herein is exemplary and for illustrative purposes.

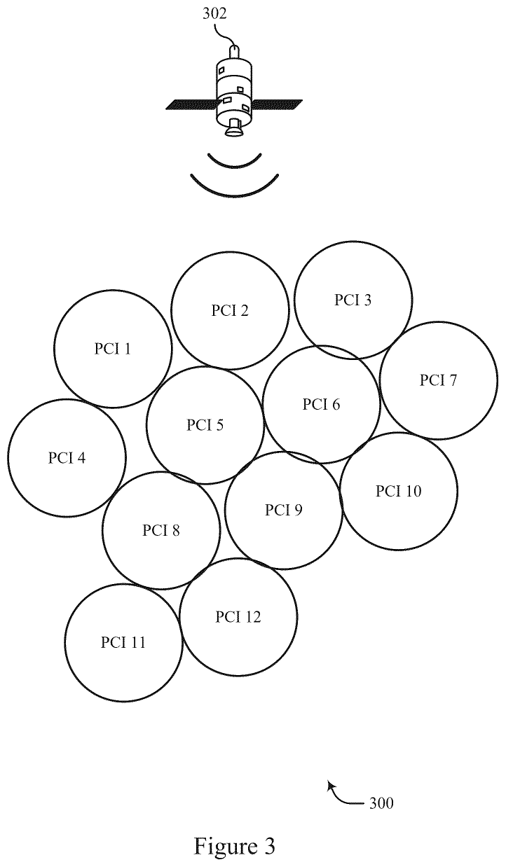

FIG. 3 illustrates a cell mapping scenario 300 in an NTN. A satellite 302 may be configured to or operable to support a set of beams (also referred to as satellite beams) for wireless communication (e.g., for downlink and/or uplink communication). For example, a beam may carry one or more SSBs. In some cases, a beam may be referred to as an SSB beam. Each SSB can be transmitted and received in a specific direction using a beam. Multiple beams may be used by the satellite 302 to cover different coverage areas. The satellite 302 may be an example of NE as described herein. In the example of FIG. 3, each beam may be a cell (e.g., a geographic coverage area of the satellite 302) and each beam may be associated with a respective PCI (i.e., different PCI). For example, a first satellite beam may be associated with a first PCI (PCI 1), a second satellite beam may be associated with a second PCI (PCI 2), a third satellite beam may be associated with a third PCI (PCI 3), a fourth satellite beam may be associated with a fourth PCI (PCI 4), a fifth satellite beam may be associated with a fifth PCI (PCI 5), a sixth satellite beam may be associated with a sixth PCI (PCI 6), a seventh satellite beam may be associated with a seventh PCI (PCI 7), an eighth satellite beam may be associated with an eighth PCI (PCI 8), a nineth satellite beam may be associated with a nineth PCI (PCI 9), a tenth satellite beam may be associated with a tenth PCI (PCI 10), an eleventh satellite beam may be associated with an eleventh PCI (PCI 11), and twelfth satellite beam may be associated with a twelfth PCI (PCI 12). It should be understood that the numbering of PCI provided herein is exemplary and for illustrative purposes.

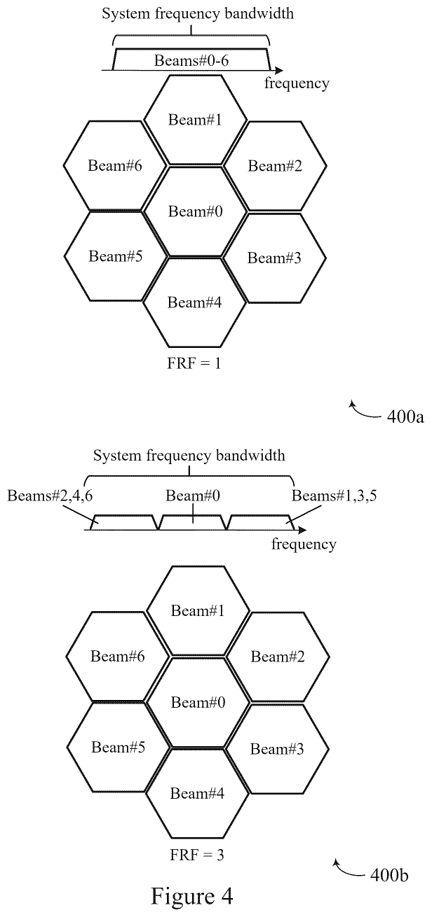

FIG. 4 illustrates FRF scenarios in an NTN. In the example of FIG. 4, scenario 400a illustrates an example where an FRF is equal to one (FRF=1) (also referred to as FR-1 scheme), while scenario 400b illustrates an example where the FRF is equal to three (FRF=3) (also referred to as FR-3 scheme). In some cases, frequency reuse schemes (FRF>1) have been proposed to mitigate inter-cell/beam co-channel interference. Spatial frequency reuse techniques improve the signal-to-interference-and-noise ratio (SINR) but can inherently limit the per-beam bandwidth and the system capacity. For instance, in the scenario 400a, beams 0-6 share the same carrier frequency and bandwidth of the available system bandwidth. In the example of scenario 400b, the FRF-3 scheme offers a protection against inter-cell interference. However, only a third of the spectral resources are used within each cell, as shown in the scenario 400b. For instance, in the scenario 400b, beams 2, 4, 6 are allocated a first BWP of the available system bandwidth (e.g., spectral resources), beam 0 is allocated a second BWP of the available system bandwidth, and beams 1, 3, 5 are allocated a third BWP of the available system bandwidth. NTN system level simulations have shown potential gains for the FRF-3 scheme over the FRF-1 scheme.

In scenarios of operation with one beam per cell, lower layer (also referred to as Layer-1 (L1)), such as physical (PHY) layer behavior can be less complex although more higher layer procedures (also referred to as Layer-2 (L2) and/or Layer-3 (L3)), such as RRC layer, medium access control (MAC) layer, radio link control (RLC) layer, etc. are required due to frequent handover, especially for Low Earth Orbit (LEO). In scenarios of operation with multiple beams per cell, L1 beam management as described in 3GPP Release 15 can be reused frequently. In scenarios of FRF greater than 1 (FRF>1), the concept of using BWPs to enable a frequency reuse was discussed in 3GPP Release 16. It was proposed that mapping different BWPs to different parts of a system bandwidth and different beams might allow L1-based mobility within a large cell (e.g., coverage area). Specifically, for a flexible frequency reuse, a beam-specific BWP can be configured. The objective would be to replace the component carrier which is not as flexible as a BWP. The same component carrier can be used on all cells (e.g., FR-1), but each beam would be assigned a beam-specific BWP. For the configuration of beam-specific BWPs in NTN, the same configuration parameters can be used, including starting position, size, and the subcarrier spacing. However, an indication of the associated beam is to be added: a beam-index (CSI-RS associated with the beam).

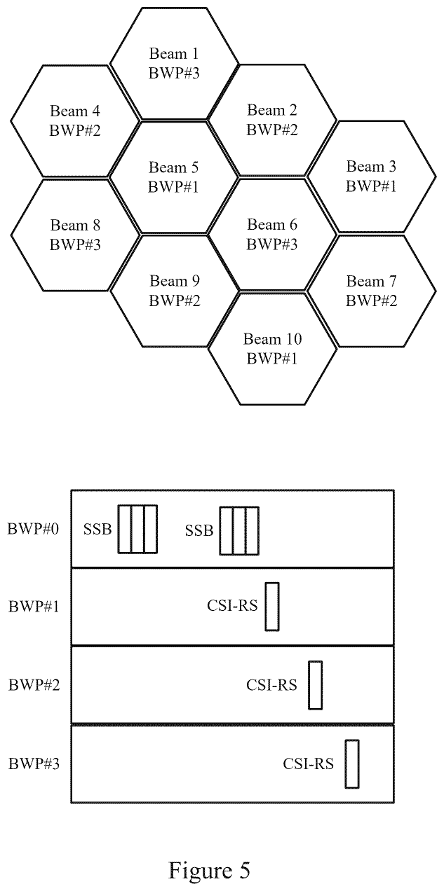

FIG. 5 illustrates an example scenario 500 where multiple beams are in a cell and each beam is mapped to a BWP. The scenario 500, for instance, represents an implementation where FRF is equal to 3 (FR-3). In legacy NR specifications, a device first needs to switch from initial BWP #0 to the serving BWP #x. Similarly, in the scenario 500, SSBs via all beams 1-10 within the cell are transmitted on BWP #0. Further, beams 3, 5, 10 are allocated BWP #1, beams 2, 4, 7, 9 are allocated BWP #2, and beams 1, 6, 8 are allocated BWP #3. The UE performs Downlink (DL) synchronization and Random Access Channel (RACH) procedure on BWP #0. After RRC connected, the BWP corresponding to the detected SSB can be configured to the UE as an active BWP (e.g., RRC-configured BWP). This involves that the satellite can transmit the SSB on BWP #0 in addition to transmit Physical Downlink Control Channel (PDCCH)/PDSCH on the associated BWP. For instance, BWP #0 can be used for initial cell access with all beams corresponding to SSB indices. For connected UE, the active BWP #1, #2, or #3 can be used with several beams. Assuming a device makes measurements and transmits CSI-RS on a BWP that is different from the BWP of the current serving satellite beam, the device will need to retune its carrier frequency for measurements and perform frequency compensation to report measurements frequently via CSI-RS, e.g., every 10 seconds typically in LEO scenario with earth-moving beams.

For discontinuous reception (DRX), a medium access control (MAC) entity may be configured by RRC with a DRX functionality that controls the UE's PDCCH monitoring activity for the MAC entity's cell (C)-Radio Network Temporary Identifier (RNTI), cancellation indicator (CI)-RNTI, Common Search (CS)-RNTI, Interruption (INT)-RNTI, Slot Format Indicator (SFI)-RNTI, Semi-Persistent (SP)-CSI-RNTI, Transmit Power Control (TPC)-PUCCH-RNTI, TPC-PUSCH-RNTI, TPC-SRS-RNTI, Air Interface (AI)-RNTI, SL-RNTI, SL-CS-RNTI and Sidelink (SL) Semi-Persistent Scheduling V-RNTI. When using DRX operation, the MAC entity shall also monitor PDCCH according to requirements found in other clauses of this specification. When in RRC_CONNECTED, if DRX is configured, for all the activated Serving Cells, the MAC entity may monitor the PDCCH discontinuously using the DRX operation specified in this clause; otherwise the MAC entity shall monitor the PDCCH as specified in 3GPP technical specification (TS) 38.213.

RRC controls DRX operation by configuring the following parameters:
drx-onDurationTimer: the duration at the beginning of a DRX cycle;
drx-SlotOffset: the delay before starting the drx-onDurationTimer;
drx-InactivityTimer: the duration after the PDCCH occasion in which a PDCCH indicates a new uplink (UL), DL or SL transmission for the MAC entity;
drx-RetransmissionTimerDL (per DL hybrid automatic repeat request (HARQ) process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX cycle starts;
drx-NonIntegerLongCycleStartOffset (optional): the Long DRX cycle and drx-StartOffset which defines the subframe where the Long and Short DRX cycle start, when the length of the Long DRX cycle and/or the short DRX cycle is not an integer;
drx-ShortCycle (optional): the Short DRX cycle;
drx-NonIntegerShortCycle (optional): the Short DRX cycle whose length is not an integer;
drx-ShortCycleTimer (optional): the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
drx-RetransmissionTimerSL (per sidelink process): the maximum duration until a grant for SL retransmission is received;
drx-HARQ-RTT-TimerSL (per sidelink process): the minimum duration before an SL retransmission grant is expected by the MAC entity;
drx-LastTransmissionUL (optional): the configuration to start drx-HARQ-RTT-TimerUL after the last transmission within a bundle;
ps-Wakeup (optional): the configuration to start associated drx-onDurationTimer in case Downlink Control Information of Power Saving (DCP) is monitored but not detected;
ps-TransmitOtherPeriodicCSI (optional): the configuration to report periodic Channel State Information (CSI) that is not L1-Reference Signal Received Power (RSRP) on physical uplink control channel (PUCCH) during the time duration indicated by drx-onDurationTimer in case DCP is configured but associated drx-onDurationTimer is not started;
ps-TransmitPeriodicLI-RSRP (optional): the configuration to transmit periodic CSI that is L1-RSRP on PUCCH during the time duration indicated by drx-onDurationTimer in case DCP is configured but associated drx-onDurationTimer is not started;
DLHARQ-FeedbackDisabled (optional): the configuration to disable HARQ feedback per DL HARQ process;
uplinkHARQ-Mode (optional): the configuration to set HARQmodeA or HARQmodeB per UL HARQ process;
disableCG-RetransmissionMonitoring (optional): the configuration to disable starting drx-HARQ-RTT-TimerUL for UL transmission over a configured uplink grant;
drx-TimeReferenceSFN (optional): the reference System Frame Number (SFN) used in determining the start time of DRX on durations when short and/or long DRX cycle is not an integer.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are: drx-onDurationTimer, drx-InactivityTimer. The DRX parameters that are common to the DRX groups are: drx-SlotOffset, drx-RetransmissionTimerDL, drx-RetransmissionTimerUL, drx-LongCycleStartOffset, drx-NonIntegerLongCycleStartOffset, drx-ShortCycle (optional), drx-NonIntegerShortCycle (optional), drx-ShortCycleTimer (optional), drx-HARQ-RTT-TimerDL, and drx-HARQ-RTT-TimerUL.

When DRX is configured, the Active Time for Serving Cells in a DRX group includes the time while:
drx-onDurationTimer or drx-InactivityTimer configured for the DRX group is running; or
drx-RetransmissionTimerDL, drx-RetransmissionTimerUL or drx-RetransmissionTimerSL is running on any Serving Cell in the DRX group; or
ra-ContentionResolutionTimer is running; or
a Scheduling Request is sent on PUCCH and is pending. If this Serving Cell is part of a non-terrestrial network, the Active Time is started after the Scheduling Request transmission that is performed when the SR_COUNTER is 0 for all the Scheduling Request (SR) configurations with pending SR(s) plus the UE-gNB Round Trip Time (RTT); or
a PDCCH indicating a new transmission addressed to the C-RNTI of the MAC entity has not been received after successful reception of a Random Access Response for the Random Access Preamble not selected by the MAC entity among the contention-based Random Access Preamble.

The following MAC timers can be used for DRX operation in a non-terrestrial network:
HARQ-RTT-TimerDL-NTN (per DL HARQ process configured with HARQ feedback enabled): the minimum duration before a DL assignment for HARQ retransmission is expected by the MAC entity;
HARQ-RTT-TimerUL-NTN (per UL HARQ process configured with HARQModeA): the minimum duration before a UL HARQ retransmission grant is expected by the MAC entity.

When DRX is not configured and multicast DRX is configured for a G-RNTI or G-CS-RNTI, the MAC entity shall:
1> monitor the PDCCH as specified in TS 38.213;
1> if a MAC PDU is received in a configured DL assignment for unicast; or
1> if the PDCCH indicates a DL unicast transmission:
   2> stop the drx-RetransmissionTimerDL-PTM for the corresponding HARQ process.

When DRX is configured, the MAC entity shall:
1> if a MAC PDU is received in a configured DL assignment for unicast:
   2> if this Serving Cell is configured with DLHARQ-FeedbackDisabled:
      3> if the corresponding HARQ process is configured with HARQ feedback enabled:
         4> set HARQ-RTT-TimerDL-NTN for the corresponding HARQ process equal to drx-HARQ-RTT-TimerDL plus the latest available UE-gNB RTT value;
         4> start the HARQ-RTT-TimerDL-NTN for the corresponding HARQ process in the first symbol after the end of the corresponding transmission carrying the DL HARQ feedback.
   2> else:
      3> start the drx-HARQ-RTT-TimerDL for the corresponding HARQ process in the first symbol after the end of the corresponding transmission carrying the DL HARQ feedback.
   2> stop the drx-RetransmissionTimerDL for the corresponding HARQ process;
   2> stop the drx-RetransmissionTimerDL-PTM for the corresponding HARQ process.
1> if a MAC PDU is transmitted in a configured uplink grant and Listen Before Talk (LBT) failure indication is not received from lower layers:
   2> if this Serving Cell is configured with uplinkHARQ-Mode:
      3> if the corresponding HARQ process is configured as HARQModeA:
         4> set HARQ-RTT-TimerUL-NTN for the corresponding HARQ process equal to drx-HARQ-RTT-TimerUL plus the latest available UE-gNB RTT value;
         4> if drx-LastTransmissionUL is configured:
         5> start the HARQ-RTT-TimerUL-NTN for the corresponding HARQ process in the first symbol after the end of the last transmission (within a bundle) of the corresponding physical uplink shared channel (PUSCH) transmission.
         4> else:
         5> start the HARQ-RTT-TimerUL-NTN for the corresponding HARQ process in the first symbol after the end of the first transmission (within a bundle) of the corresponding PUSCH transmission.
   2> else:
      3> if disableCG-RetransmissionMonitoring is not configured for the configured uplink grant:
         4> if drx-LastTransmissionUL is configured:
         5> start the drx-HARQ-RTT-TimerUL for the corresponding HARQ process in the first symbol after the end of the last transmission (within a bundle) of the corresponding PUSCH transmission.
         4> else:
         5> start the drx-HARQ-RTT-TimerUL for the corresponding HARQ process in the first symbol after the end of the first transmission (within a bundle) of the corresponding PUSCH transmission.
   2> stop the drx-RetransmissionTimerUL for the corresponding HARQ process at the first transmission (within a bundle) of the corresponding PUSCH transmission.
1> if a MAC PDU is transmitted in a configured sidelink grant:
   2> if the PUCCH resource is configured:
      3> start the drx-HARQ-RTT-TimerSL for the corresponding HARQ process in the first symbol after the end of the corresponding PUCCH transmission carrying the SL HARQ feedback; or
      3> start the drx-HARQ-RTT-TimerSL for the corresponding HARQ process in the first symbol after the end of the corresponding PUCCH resource for the SL HARQ feedback when the PUCCH is not transmitted;
3> stop the drx-RetransmissionTimerSL for the corresponding HARQ process.
   2> else:
      3> start the drx-HARQ-RTT-TimerSL for the corresponding HARQ process at the first symbol after the end of the corresponding Physical Sidelink Shared Channel (PSSCH) transmission;
3> stop the drx-RetransmissionTimerSL for the corresponding HARQ process.
1> if a drx-HARQ-RTT-TimerDL expires:
   2> if the data of the corresponding HARQ process was not successfully decoded:
      3> start the drx-RetransmissionTimerDL for the corresponding HARQ process in the first symbol after the expiry of drx-HARQ-RTT-TimerDL.
1> if a HARQ-RTT-TimerDL-NTN expires:
   2> if the data of the corresponding HARQ process was not successfully decoded:
      3> start the drx-RetransmissionTimerDL for the corresponding HARQ process in the first symbol after the expiry of HARQ-RTT-TimerDL-NTN.
1> if a drx-HARQ-RTT-TimerUL expires:
   2> start the drx-RetransmissionTimerUL for the corresponding HARQ process in the first symbol after the expiry of drx-HARQ-RTT-TimerUL.
1> if a HARQ-RTT-TimerUL-NTN expires:
   2> start the drx-RetransmissionTimerUL for the corresponding HARQ process in the first symbol after the expiry of HARQ-RTT-TimerUL-NTN.
1> if a drx-HARQ-RTT-TimerSL expires:
   2> if a HARQ Negative Acknowledgement (NACK) feedback for the corresponding HARQ process is transmitted on PUCCH; or
   2> if a HARQ NACK feedback for the corresponding HARQ process is generated but not transmitted on PUCCH; or
   2> if the PUCCH resource is not configured for the SL grant:
      3> start the drx-RetransmissionTimerSL for the corresponding HARQ process in the first symbol after the expiry of drx-HARQ-RTT-TimerSL.
NOTE: The UE handles the drx-RetransmissionTimerSL operation when sl-PUCCH-Config is configured by RRC but PUCCH resource is not scheduled same as when sl-PUCCH-Config is not configured.
1> if a DRX Command MAC control element (CE) indicated by PDCCH addressed to C-RNTI or CS-RNTI, or by a configured DL assignment for unicast transmission or a Long DRX Command MAC CE is received:
   2> stop drx-onDurationTimer for each DRX group;
   2> stop drx-InactivityTimer for each DRX group.
1> if drx-InactivityTimer for a DRX group expires:
   2> if the Short DRX cycle is configured:
      3> start or restart drx-ShortCycleTimer for this DRX group in the first symbol after the expiry of drx-InactivityTimer;
3> use the Short DRX cycle for this DRX group.
   2> else:
      3> use the Long DRX cycle for this DRX group.
1> if a DRX Command MAC CE indicated by PDCCH addressed to C-RNTI or CS-RNTI, or by a configured DL assignment for unicast transmission is received:
   2> if the Short DRX cycle is configured:
      3> start or restart drx-ShortCycleTimer for each DRX group in the first symbol after the end of DRX Command MAC CE reception;
3> use the Short DRX cycle for each DRX group.
   2> else:
      3> use the Long DRX cycle for each DRX group.
1> if drx-ShortCycleTimer for a DRX group expires:
   2> use the Long DRX cycle for this DRX group.
1> if a Long DRX Command MAC CE is received:
   2> stop drx-ShortCycleTimer for each DRX group;
   2> use the Long DRX cycle for each DRX group.
1> if the drx-NonIntegerLongCycleStartOffset is configured:
   2> increment DRX_SFN_COUNTER by 1 in the first symbol of a slot in which SFN changes to 0;
   2> if DRX is (re-) configured by RRC:
      3> set DRX_SFN_COUNTER to 0 in the first symbol of the slot immediately after the successful completion of the RRC (re-) configuration;
1> if the Short DRX cycle is used for a DRX group and the drx-NonIntegerShortCycle is not configured, and [(SFN×10)+subframe number] modulo (drx-ShortCycle)=(drx-StartOffset) modulo (drx-ShortCycle); or
1> if the Short DRX cycle is used for a DRX group and the drx-NonIntegerShortCycle is configured, and floor ([(DRX_SFN_COUNTER×10240)+ (SFN×10)+subframe number] modulo (drx-NonIntegerShortCycle))=floor ([(drx-TimeReferenceSFN×10)+drx-StartOffset] modulo (drx-NonIntegerShortCycle)):
   2> start drx-onDurationTimer for this DRX group after drx-SlotOffset from the beginning of the subframe.
1> if the Long DRX cycle is used for a DRX group and the drx-NonIntegerLongCycleStartOffset is not configured, and [(SFN×10)+subframe number] modulo (drx-LongCycle)=drx-StartOffset; or
1> if the Long DRX cycle is used for a DRX group and the drx-NonIntegerLongCycleStartOffset is configured, and floor ([(DRX_SFN_COUNTER×10240)+(SFN×10)+subframe number] modulo (drx-NonIntegerLongCycle))=floor ([(drx-TimeReferenceSFN×10)+drx-StartOffset] modulo (drx-NonIntegerLongCycle)):
   2> if DCP monitoring is configured for the active DL BWP as specified in TS 38.213 [6], clause 10.3:
      3> if DCP indication associated with the current DRX cycle received from lower layer indicated to start drx-onDurationTimer, as specified in TS 38.213; or
      3> if all DCP occasion(s) in time domain, as specified in TS 38.213, associated with the current DRX cycle occurred in Active Time considering grants/assignments/DRX Command MAC CE/Long DRX Command MAC CE received and Scheduling Request sent until 4 ms prior to start of the last DCP occasion, or during a measurement gap, or when the MAC entity monitors for a PDCCH transmission on the search space indicated by recoverySearchSpaceld of the SpCell identified by the C-RNTI while the ra-Response Window is running (as specified in clause 5.1.4); or
      3> if ps-Wakeup is configured with value true and DCP indication associated with the current DRX cycle has not been received from lower layers:
         4> start drx-onDurationTimer after drx-SlotOffset from the beginning of the subframe.
   2> else:
      3> start drx-onDurationTimer for this DRX group after drx-SlotOffset from the beginning of the subframe.
NOTE 2: In case of unaligned SFN across carriers in a cell group, the SFN of the SpCell is used to calculate the DRX duration.
1> if a DRX group is in Active Time:
   2> monitor the PDCCH on the Serving Cells in this DRX group as specified in TS 38.213 [6];
   2> if the PDCCH indicates a DL transmission; or
   2> if the PDCCH indicates a one-shot HARQ feedback as specified in clause 9.1.4 of TS 38.213; or
   2> if the PDCCH indicates a retransmission of HARQ feedback as specified in clause 9.1.5 of TS 38.213:
      3> if this Serving Cell is configured with DLHARQ-FeedbackDisabled:
         4> if the corresponding HARQ process is configured with HARQ feedback enabled:
         5> set HARQ-RTT-TimerDL-NTN for the corresponding HARQ process equal to drx-HARQ-RTT-TimerDL plus the latest available UE-gNB RTT value;
         5> start the HARQ-RTT-TimerDL-NTN for the corresponding HARQ process in the first symbol after the end of the corresponding transmission carrying the DL HARQ feedback.
      3> else:
         4> start or restart the drx-HARQ-RTT-TimerDL for the corresponding HARQ process(es) whose HARQ feedback is reported in the first symbol after the end of the corresponding transmission carrying the DL HARQ feedback.
NOTE 3: When HARQ feedback is postponed by PDSCH-to-HARQ_feedback timing indicating an inapplicable kl value, as specified in TS 38.213, the corresponding transmission opportunity to send the DL HARQ feedback is indicated in a later PDCCH requesting the HARQ-Acknowledgement (ACK) feedback.
   3> stop the drx-RetransmissionTimerDL for the corresponding HARQ process(es) whose HARQ feedback is reported;
   3> stop the drx-RetransmissionTimerDL-PTM for the corresponding HARQ process;
   3> if the PDSCH-to-HARQ_feedback timing indicate an inapplicable kl value as specified in TS 38.213:
      4> start the drx-RetransmissionTimerDL in the first symbol after the (end of the last) PDSCH transmission (within a bundle) for the corresponding HARQ process.
2> if the PDCCH indicates a UL transmission:
   3> if this Serving Cell is configured with uplinkHARQ-Mode:
      4> if the corresponding HARQ process is configured as HARQModeA:
         5> set HARQ-RTT-TimerUL-NTN for the corresponding HARQ process equal to drx-HARQ-RTT-TimerUL plus the latest available UE-gNB RTT value;
         5> if drx-LastTransmissionUL is configured:
         6> start the HARQ-RTT-TimerUL-NTN for the corresponding HARQ process in the first symbol after the end of the last transmission (within a bundle) of the corresponding PUSCH transmission.
         5> else:
         6> start the HARQ-RTT-TimerUL-NTN for the corresponding HARQ process in the first symbol after the end of the first transmission (within a bundle) of the corresponding PUSCH transmission.
   3> else:
      4> if drx-LastTransmissionUL is configured:
         5> start the drx-HARQ-RTT-TimerUL for the corresponding HARQ process in the first symbol after the end of the last transmission (within a bundle) of the corresponding PUSCH transmission.
      4> else:
         5> start the drx-HARQ-RTT-TimerUL for the corresponding HARQ process in the first symbol after the end of the first transmission (within a bundle) of the corresponding PUSCH transmission.
   3> stop the drx-RetransmissionTimerUL for the corresponding HARQ process.
2> if the PDCCH indicates an SL transmission:
   3> if the PUCCH resource is configured:
      4> start the drx-HARQ-RTT-TimerSL for the corresponding HARQ process in the first symbol after the end of the corresponding PUCCH transmission carrying the SL HARQ feedback; or
      4> start the drx-HARQ-RTT-TimerSL for the corresponding HARQ process in the first symbol after the end of the corresponding PUCCH resource for the SL HARQ feedback when the PUCCH is not transmitted;
      4> stop the drx-RetransmissionTimerSL for the corresponding HARQ process.
   3> else:
      4> start the drx-HARQ-RTT-TimerSL for the corresponding HARQ process at the first symbol after end of PDCCH occasion;
      4> stop the drx-RetransmissionTimerSL for the corresponding HARQ process.
2> if the PDCCH indicates a new transmission (DL, UL or SL) on a Serving Cell in this DRX group:
   3> start or restart drx-InactivityTimer for this DRX group in the first symbol after the end of the PDCCH reception.
NOTE 3a: A PDCCH indicating activation of Semi-Persistent Scheduling (SPS), configured grant type 2, or configured sidelink grant of configured grant Type 2 is considered to indicate a new transmission.
NOTE 3b: If the PDCCH reception includes two PDCCH candidates from corresponding search spaces, as described in clause 10.1 in TS 38.213, start or restart drx-InactivityTimer for this DRX group in the first symbol after the end of the PDCCH candidate that ends later in time.
   2> if a HARQ process receives DL feedback information and acknowledgement is indicated:
      3> stop the drx-RetransmissionTimerUL for the corresponding HARQ process.
1> if DCP monitoring is configured for the active DL BWP as specified in TS 38.213, clause 10.3; and
1> if the current symbol n occurs within drx-onDurationTimer duration; and
1> if drx-onDurationTimer associated with the current DRX cycle is not started as specified in this clause:
   2> if the MAC entity would not be in Active Time considering grants/assignments/DRX Command MAC CE/Long DRX Command MAC CE received and Scheduling Request sent until 4 ms prior to symbol n when evaluating all DRX Active Time conditions as specified in this clause; and
   2> if allowCSI-SRS-Tx-MulticastDRX-Active is not configured, or if cfr-ConfigMulticast is not configured for any of the active BWP(s) of the Serving Cell(s), or if all multicast DRXes would not be in Active Time considering multicast assignments/DRX Command MAC CE for Multicast Broadcast Service (MBS) multicast received until 4 ms prior to symbol n when evaluating all DRX Active Time conditions as specified in Clause 5.7b and all multicast sessions are configured with multicast DRX:
      3> not transmit periodic SRS and semi-persistent SRS defined in TS 38.214;
      3> not report semi-persistent CSI configured on PUSCH;
      3> not report semi-persistent CSI on PUCCH;
      3> if ps-TransmitPeriodicLI-RSRP is not configured with value true:
         4> not report periodic CSI that is L1-RSRP on PUCCH.
      3> if ps-TransmitOtherPeriodicCSI is not configured with value true:
         4> not report periodic CSI that is not L1-RSRP on PUCCH.
1> else:
   2> in current symbol n, if a DRX group would not be in Active Time considering grants/assignments scheduled on Serving Cell(s) in this DRX group and DRX Command MAC CE/Long DRX Command MAC CE received and Scheduling Request sent until 4 ms prior to symbol n when evaluating all DRX Active Time conditions as specified in this clause; and
   2> if allowCSI-SRS-Tx-MulticastDRX-Active is not configured, or if cfr-ConfigMulticast is not configured for any of the active BWP(s) of the Serving Cell(s), or, in current symbol n, if all multicast DRXes corresponding to the DRX group would not be in Active Time considering multicast assignments/DRX Command MAC CE for MBS multicast received until 4 ms prior to symbol n when evaluating all DRX Active Time conditions as specified in Clause 5.7b and all multicast sessions corresponding to the DRX group are configured with multicast DRX:
      3> not transmit periodic SRS and semi-persistent SRS defined in TS 38.214 in this DRX group;
      3> not report CSI on PUCCH and semi-persistent CSI configured on PUSCH in this DRX group.
   2> if CSI masking (csi-Mask) is setup by upper layers:
      3> in current symbol n, if drx-onDurationTimer of a DRX group would not be running considering grants/assignments scheduled on Serving Cell(s) in this DRX group and DRX Command MAC CE/Long DRX Command MAC CE received until 4 ms prior to symbol n when evaluating all DRX Active Time conditions as specified in this clause; and
      3> if allowCSI-SRS-Tx-MulticastDRX-Active is not configured, or if cfr-ConfigMulticast is not configured for any of the active BWP(s) of the Serving Cell(s), or, in current symbol n, if drx-onDurationTimerPTM(s) of all multicast DRXes corresponding to the DRX group would not be running considering DRX Command MAC CE for MBS multicast received until 4 ms prior to symbol n when evaluating all DRX Active Time conditions as specified in Clause 5.7b and all multicast sessions corresponding to the DRX group are configured with multicast DRX:
         4> not report CSI on PUCCH in this DRX group.
NOTE 4: If a UE multiplexes a CSI configured on PUCCH with other overlapping uplink control information (UCI(s)) according to the procedure specified in TS 38.213 clause 9.2.5 and this CSI multiplexed with other UCI(s) would be reported on a PUCCH resource either outside DRX Active Time of the DRX group in which this PUCCH is configured or outside the on-duration period of the DRX group in which this PUCCH is configured if CSI masking is setup by upper layers, it is up to UE implementation whether to report this CSI multiplexed with other UCI(s).

Regardless of whether the MAC entity is monitoring PDCCH or not on the Serving Cells in a DRX group, the MAC entity transmits HARQ feedback, aperiodic CSI on PUSCH, and aperiodic SRS defined in TS 38.214 on the Serving Cells in the DRX group when such is expected. The MAC entity needs not to monitor the PDCCH if it is not a complete PDCCH occasion, e.g., the Active Time starts or ends in the middle of a PDCCH occasion.

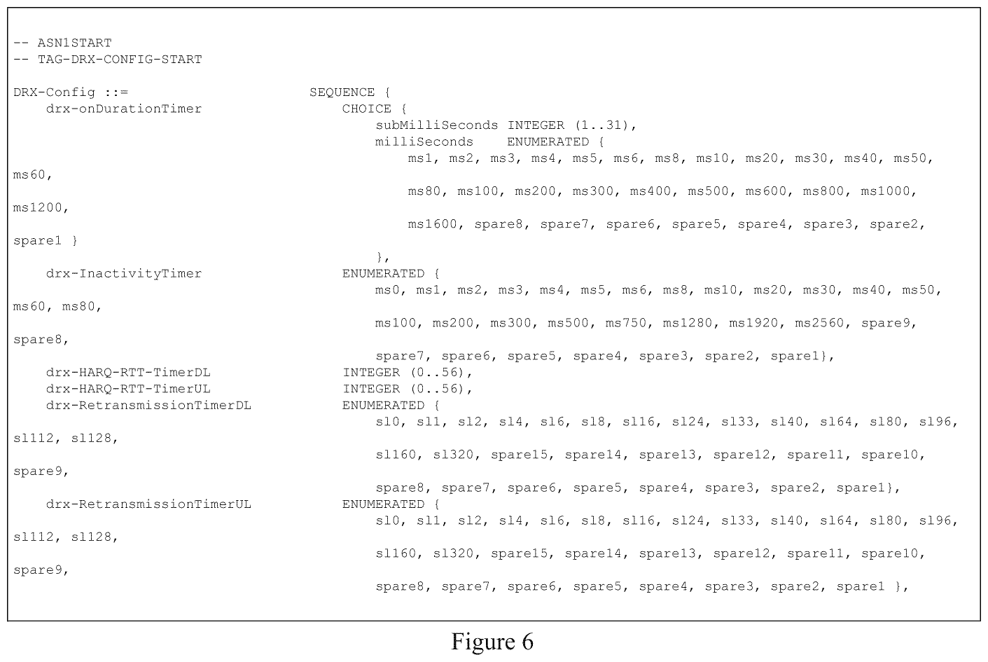

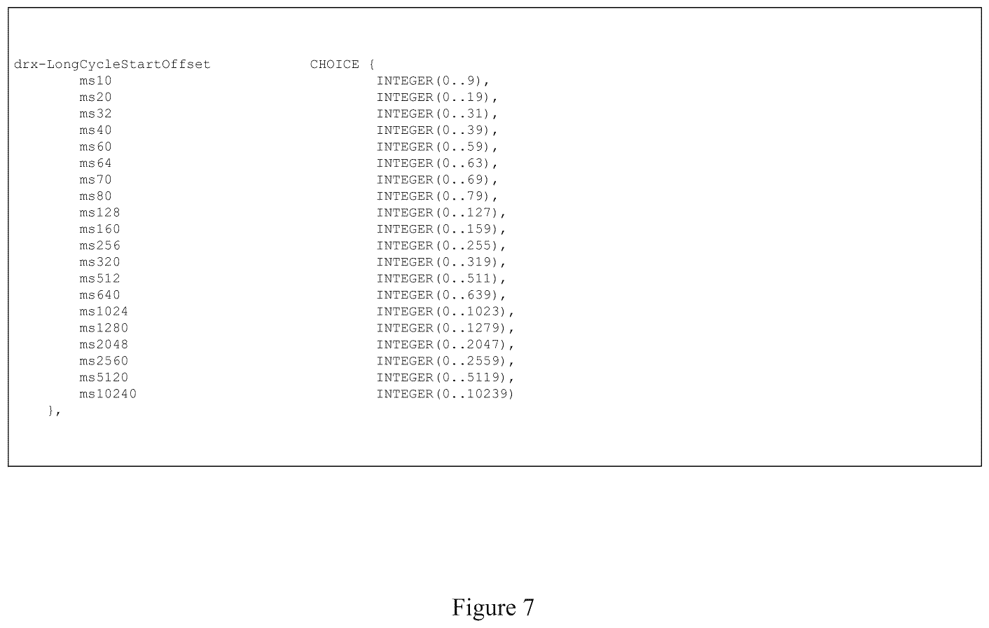

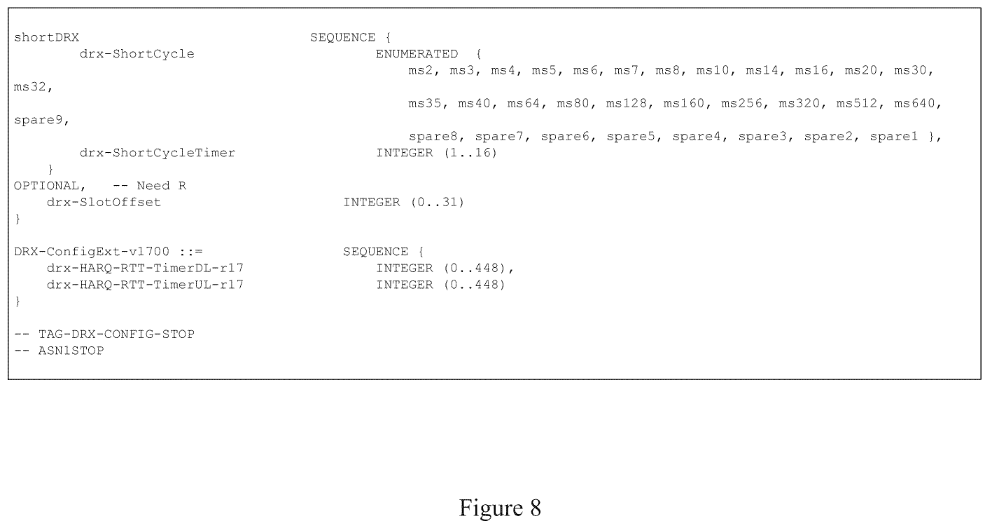

FIGS. 6-8 illustrate an example information element for DRX configuration. Table 1 below includes example descriptions of fields that can be included in the example information element for DRX configuration.

TABLE 1
DRX-Config IE field descriptions
DRX-Config field descriptions

drx-HARQ-RTT-TimerDL
Value in number of symbols of the BWP where the transport block was received. drx-HARQ-
RTT-TimerDL-r17 is only applicable for subcarrier spacing (SCS) 480 kHz and 960 kHz. If
configured, the UE shall ignore drx-HARQ-RTT-TimerDL (without suffix) for SCS 480 kHz and
960 kHz.
drx-HARQ-RTT-TimerUL
Value in number of symbols of the BWP where the transport block was transmitted. drx-HARQ-
RTT-TimerUL-r17 is only applicable for SCS 480 kHz and 960 kHz. If configured, the UE shall
ignore drx-HARQ-RTT-TimerUL (without suffix) for SCS 480 kHz and 960 kHz.
drx-InactivityTimer
Value in multiple integers of 1 ms. ms0 corresponds to 0, ms1 corresponds to 1 ms, ms2
corresponds to 2 ms, and so on.
drx-LongCycleStartOffset
drx-LongCycle in ms and drx-StartOffset in multiples of 1 ms. If drx-ShortCycle is configured,
the value of drx-LongCycle shall be a multiple of the drx-ShortCycle value.
drx-onDurationTimer
Value in multiples of 1/32 ms (subMilliSeconds) or in ms (milliSecond). For the latter, value ms1
corresponds to 1 ms, value ms2 corresponds to 2 ms, and so on.
drx-RetransmissionTimerDL
Value in number of slot lengths of the BWP where the transport block was received. value sl0
corresponds to 0 slots, sl1 corresponds to 1 slot, sl2 corresponds to 2 slots, and so on.
drx-RetransmissionTimerUL
Value in number of slot lengths of the BWP where the transport block was transmitted. sl0
corresponds to 0 slots, sl1 corresponds to 1 slot, sl2 corresponds to 2 slots, and so on.
drx-ShortCycleTimer
Value in multiples of drx-ShortCycle. A value of 1 corresponds to drx-ShortCycle, a value of 2
corresponds to 2 * drx-ShortCycle and so on.
drx-ShortCycle
Value in ms. ms1 corresponds to 1 ms, ms2 corresponds to 2 ms, and so on.
drx-SlotOffset
Value in 1/32 ms. Value 0 corresponds to 0 ms, value 1 corresponds to 1/32 ms, value 2
corresponds to 2/32 ms, and so on.

Aspects of cell DTX/DRX (e.g., for 3GPP Rel-18) are provided below. The following signals/channels are expected to be impacted (e.g., either by UE not monitoring reception for DL signals/channels or not transmitting for UL signals/channels) by cell DTX/DRX, respectively, as follows: (1) UE doesn't monitor SPS occasions during cell DTX non-active period, e.g., gNB is assumed to not transmit PDSCH to that UE on such SPS occasions during the Cell DTX non-active periods. (2) UE does not transmit on CG occasions during cell DRX non-active periods. (3) UE does not transmit SR occasions overlapping with Cell DRX non-active periods, e.g., SR transmissions are dropped during the cell DRX non-active periods. (4) UE does not expect to receive and/or process Periodic/Semi-persistent CSI-RS configured in CSI report configuration in CSI-ReportConfig with reportQuantity including RI (for CSI reporting), during non-active periods of cell DTX. (5) UE does not expect to transmit Periodic/Semi-persistent CSI reports during non-active periods of cell DRX. (6) UE does not expect to transmit Periodic/Semi-persistent SRS during non-active periods of cell DRX, except when the SRS is for positioning. (7) UE does not expect to monitor PDCCHs associated with DCI format 2_0-DCI Format 2_5, during non-active periods of cell DTX.

The following signals/channels are not expected to be impacted by cell DTX/DRX, as follows: (1) No impact to RACH, paging, and SIBs in idle/inactive for both gNB and Rel-18 and legacy UEs. (2) UE monitors PDCCH for RAR during Cell DTX non-active time. The ra-Response Window could be started as legacy. (3) UE monitors PDCCH for msg4 during Cell DTX non-active time. The ra-ContentionResolutionTimer could be started as legacy. (4) Once gNB recognizes there is an emergency call or public safety related service (e.g. MPS/MCS), the network ensures there is no impact to the emergency call (e.g., may deactivate cell DTX/DRX). (5) When an DG grant is received, by the gNB during cell DRX/DTX, the UE follows the grant assignment (i.e., like in legacy). This includes DL HARQ feedback. (6) HARQ-ACK of SPS PDSCH transmitted is not impacted by non-active period of cell DRX. (7) SRS for positioning is not impacted by cell DRX operation. (8) HARQ-ACK of a DCI format without scheduling a PDSCH is not impacted by non-active period of cell DRX.

For the supported cell DTX/DRX pattern, the following has been discussed: (1) Pattern configuration for cell DRX/DTX is common for Rel-18 UEs in the cell. (2) Separate DTX and DRX configuration are supported, i.e., cell DTX can be configured without cell DRX. (3) A periodic cell DTX/DRX configuration is explicitly signaled to the UEs. (4) A periodic cell DTX/DRX pattern is configured by UE specific RRC signaling. (5) The Cell DTX/DRX configuration contains at least: periodicity, start slot/offset, on duration. (6) Cell DTX/DRX is activated/deactivated implicitly by RRC signaling, i.e., activated immediately once configured by RRC and deactivated once the RRC configuration is released. (7) The start timer formula of the onDurationTimer from UE C-DRX (including SlotOffset) are to be reused to specify the start of cellDTX-onDurationTimer (and cellDRX-onDurationTimer) in 3GPP TS 38.321, which are expected to have the same value range as UE C-DRX Long cycle. (8) On-duration and cycle parameters are common between cell DTX and DRX, when both are configured. (9) If C-DRX is configured and the retransmission timer is running, the UE is expected to monitor PDCCH, like in legacy. It is up to the network whether it schedules retransmissions out of the Cell DTX active period, i.e., when the DRX retransmission timer is running, the UE should monitor PDCCH regardless of the Cell DTX. (10) The network ensures there is at least partial overlapping between UE C-DRX on-duration and cell DTX/DRX on-duration, e.g., via configuring the cell DTX/DRX and C-DRX periodicity to be a multiple of each other.

It was also discussed to support Layer-1 (L1) signaling for activation and deactivation of cell DTX/DRX. More specifically, the following has been discussed: (1) Pattern configuration for cell DRX/DTX is common for Rel-18 UEs in the cell. (2) The group common L1 signaling using PDCCH for cell DTX/DRX activation and deactivation is based on a new DCI format 2_X, which is monitored in the common search space. (3) DCI format 2_X at least includes N information block field(s), each containing signaling of activation or deactivation of ‘a configuration of cell DTX and/or DRX’ of ‘a serving cell’. The DCI may also include spare/reserved padding bits to match the size configured for DCI 2_X, if needed. For serving cell configured with SUL, the same bit is applicable for both NUL and SUL. (4) For each serving cell configured with L1 signaling based activation/deactivation of cell DTX and/or cell DRX configuration, starting bit position of an information block of DCI format 2_X is provided by UE specific higher layer signaling. (5) An information block field of DCI format 2_X for activation and deactivation of cell DTX and DRX configuration supports separate (activation/deactivation) signaling for cell DTX and cell DRX, i.e., one activation/deactivation signaling sub-field for cell DTX configuration and one activation/deactivation signaling sub-field for cell DRX configuration, i.e., separate 1 bit indication for each of activation/deactivation for one cell DTX and one cell DRX. (6) An information block field of DCI format 2_X is variable size either 1, 2 or 3 bits, based on whether higher layer signaling configures one or both cell DTX and cell DRX for a given serving cell. If both are configured, the first bit corresponds to activation/deactivation of cell DTX configuration, and the second bit corresponds to activation/deactivation of cell DRX configuration. Otherwise, the 1 bit corresponds to the configured cell DTX or cell DRX configuration. (7) DCI format 2_X supports activation/deactivation of cell DTX/DRX configuration of multiple serving cells and supports activation/deactivation per cell, wherein a UE monitors DCI format 2_X in one serving cell. (8) A new RNTI, e.g., nes-RNTI, which is configured by higher layer, for scrambling of DCI format 2_X. (9) Both the search space set configuration with new DCI format 2_X and the DCI size for DCI format 2_X are to be included to the RRC parameter list for new DCI format 2_X for activation and deactivation of cell DTX/DRX. (10) A delay value (D) that is applied after DCI Format 2_X reception that activates/deactivates cell DTX/DRX configuration is defined, where the UE is expected to apply cell DTX or DRX activation/deactivation change at beginning of the slot k where the SCS of slot X is with respect to the active DL or UL BWP of the serving cell, respectively. Slot k is the first slot whose beginning is no earlier than the beginning of slot n+D, where n is the slot containing the PDCCH of DCI format 2_X based on SCS of PDCCH, where the possible values of D with respect to SCS are provided in Table 2 below.

TABLE 2
Values of D with respect to SCS

| SCS of PDCCH (kHz) | D (in slots) |
|---|---|
| 15 | 3 |
| 30 | 6 |
| 60 | 12 |
| 120 | 24 |
| 480 | 96 |
| 960 | 192 |

The following discusses antenna panel/port, quasi-collocation, Transmission Configuration Indication (TCI) state, and spatial relation. In some implementations, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some implementations, an antenna panel may comprise an array of antenna elements, where each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

In some implementations, a device (e.g., UE, node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports).

The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping. A Device may report its capability with respect to the “device panel” to the gNB or network. The device capability may include at least the number of “device panels”. In one implementation, the device may support Uplink (UL) transmission from one beam within a panel; with multiple panels, more than one beam (one beam per panel) may be used for UL transmission. In another implementation, more than one beam per panel may be supported/used for UL transmission.

In some of the implementations described, an antenna port is defined such that the channel over which a symbol on the antenna port is conveyed can be inferred from the channel over which another symbol on the same antenna port is conveyed.

Two antenna ports are said to be Quasi Co-Location (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:

- ‘QCL-TypeA’: {Doppler shift, Doppler spread, average delay, delay spread}
- ‘QCL-TypeB’: {Doppler shift, Doppler spread}
- ‘QCL-TypeC’: {Doppler shift, average delay}
- ‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, e.g. the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same receive beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations described, a TCI state associated with a target transmission can indicate parameters for configuring a quasi-collocation relationship between the target transmission (e.g., target reference signal of Demodulation (DM)-RS ports of the target transmission during a transmission occasion) and a source reference signal(s) (e.g., SSB/CSI-RS/Sounding Reference Signal (SRS)) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state comprises at least one source reference signal to provide a reference (UE assumption) for determining QCL and/or spatial filter.

In some of the implementations described, a spatial relation information associated with a target transmission can indicate parameters for configuring a spatial setting between the target transmission and a reference signal (e.g., SSB/CSI-RS/SRS). For example, the device may transmit the target transmission with the same spatial domain filter used for reception the reference signal (e.g., DL reference signal such as SSB/CSI-RS). In another example, the device may transmit the target transmission with the same spatial domain transmission filter used for the transmission of the reference signal (e.g., UL reference signal such as SRS). A device can receive a configuration of a plurality of spatial relation information configurations for a serving cell for transmissions on the serving cell.

In some of the implementations described, a UL TCI state is provided if a device is configured with separate DL/UL TCI by RRC signaling. The UL TCI state may comprise a source reference signal which provides a reference for determining UL spatial domain transmission filter for the UL transmission (e.g., dynamic-grant/configured-grant based PUSCH, dedicated PUCCH resources) in a component carrier (CC) or across a set of configured CCs/BWPs.

In some of the implementations described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference signal used for determining both the DL QCL information and the UL spatial transmission filter. The source reference signal determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the reference signal of DL QCL Type D in the joint TCI state. The spatial setting of the UL transmission may be according to the spatial relation with a reference to the source reference signal configured with qcl-Type set to ‘typeD’ in the joint TCI state.

In the discussion herein: (1) the following notions can be used interchangeably: network nodes, transmit-receive point (TRP), panel, set of antennas, set of antenna ports, uniform linear array, cell, node, radio head, communication (e.g., signals/channels) associated with a control resource set (CORESET) pool, communication associated with a TCI state from a transmission configuration comprising at least two TCI states; (2) A Tracking Reference Signal (TRS) can correspond to an non-zero power (NZP) CSI-RS resource set with a parameter ‘trs-info’ being configured; (3) A CSI-RS for beam management may correspond to CSI-RS associated with an NZP CSI-RS resource set with a parameter ‘repetition’ being configured; (4) A CSI-RS for CSI can correspond to an NZP CSI-RS resource set with neither parameters ‘trs-info’ nor ‘repetition’ being configured; (5) A matrix can imply a sequence of fields of an arbitrary dimension, including an array (vector) of values, a standard 2D matrix and more generally a Q-dimensional matrix (tensor) wherein Q≥2 is an integer value; (6) The notions CSI report setting, CSI report configuration, CSI reporting configuration can be used interchangeably to represent the same notion; (7) A CSI framework or procedure associated with up to 3GPP Rel-18 can be referred to as legacy behavior; (8) A beam may correspond to at least one of an NZP CSI-RS transmitted over a CSI-RS resource, or an SSB signal. Various implementations are described herein and one or more elements or features from one or more of the described implementations may be combined. Configuration and reporting aspects discussed herein may be applied for various NTN scenarios, e.g., when one beam corresponds to one cell or when multiple beams are configured within a cell. Configuration and reporting aspects discussed herein may be applied to various cell NTN cell layout configurations, e.g., earth-fixed cells, quasi earth-fixed cells, earth moving cells, etc.

Implementations described herein provide solutions for an enhanced beam hopping framework, e.g., in NTN deployments. For instance, implementations provide for deriving narrow beams for DL data transmission in NTN deployments, and may include Msg 2 beam refinement procedures.

In implementations, when a UE is configured with an explicit or implicit beam hopping indication in initial access to apply beam hopping for NTN, the UE may further be implicitly or explicitly indicated to apply a method along with PRACH transmission where this method is used to assist network in identifying a suitable narrow beam for Msg 2 transmission. Such implicit or explicit indication may be important if multiple methods are supported, and the method type indication may be needed. In implementations, an indication is configured as part of SSB configuration that indicates whether beam hopping is enabled or disabled, where upon reception of this indication in the configuration, the UE may implicitly assume that the UE is to apply a method to assist network in identifying a suitable beam for Msg 2.

In implementations, an explicit indication is configured to the UE by the network to indicate the method that is to be used with PRACH transmission for Msg 2 beam assist. Since such Msg 2 beam assist method may be common to all UEs in a cell, in one implementation an indication that beam hopping is enabled/disabled or to apply a Msg 2 beam assist method is part of system information broadcast configuration, e.g., as part of NTN parameters SIB (SIB 19) or PRACH configuration (SIB 2). In implementations, a Msg 2 beam assist method is based on extended (long) PRACH transmission, where extended here can imply PRACH transmission beyond the normal PRACH transmission duration to assist the network to identify the best transmit spatial filter for Msg 2 transmission. In such methods, the UE may use the same spatial filter for transmitting PRACH as of the received SSB spatial filter over extended duration. For instance, the UE is configured with receiving SS/PBCH at a given set of slots. The UE is further configured to transmit a PRACH following receiving an SS/PBCH, the PRACH being transmitted over a resource associated with the received SS/PBCH. The UE may further be configured with resources to transmit the same PRACH for a long duration using the received SSB spatial filter.

In implementations, a UE is configured with a repetition parameter for extended duration along with PRACH duration that would implicitly imply that each RACH occasion (RO) resources are to be repeated over the extended duration in such a way the total extended duration for PRACH transmission is multiple of the PRACH duration times the repetition parameter, e.g.,

$${N}_{dur}^{RA ‐ ext} = n \cdot {N}_{dur}^{R A} .$$

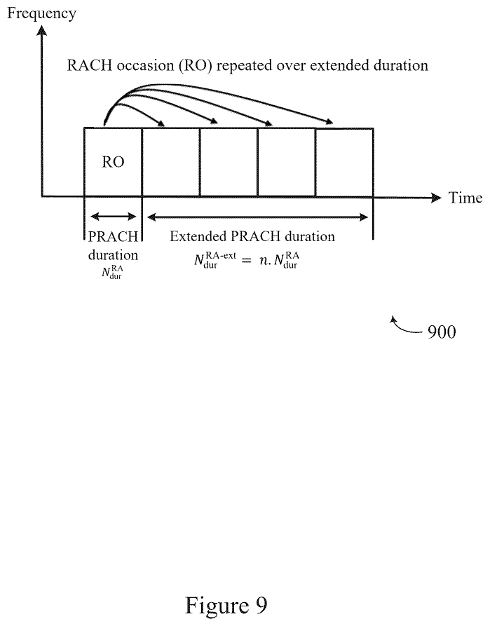

FIG. 9 illustrates an example 900 for extended PRACH duration in accordance with aspects of the present disclosure. In implementations, when a UE is configured to transmit PRACH for extended duration and is configured with a repetition parameter for extended duration, this may implicitly imply that the extended duration is within a slot of subframe, thus extending the duration of PRACH by the number of repeated ROs. For instance, this may imply that the UE can first use the RO time and frequency resources for PRACH transmission during the PRACH duration, then use the same frequency domain resources for the consecutive symbols in the slot. For example, if a UE is configured with a PRACH duration of 2 symbols in a slot

$$( {N}_{dur}^{R A} = 2 )$$

with a repetition parameter of 2 (n=2) and starting symbols with zero, the UE can transmit the preamble in the first two symbols of the slot (symbols 0,1). The UE can then send the same preamble using the same spatial filter in the next two symbols of the slot (symbols 2,3) while using the same frequency resources, and then (e.g., lastly) transmit the PRACH with same received SSB spatial filter on same frequency resources of symbols 4 and 5 of the slot.

In implementations, when the number of required time domain resources for extended PRACH duration are more than slot length, the PRACH duration may comprise contiguous symbols over multiple slots. In implementations, when the number of slots within a subframe are more than one and a UE is configured with at least one slot within a subframe for PRACH transmission, and if a UE is further configured to use transmit repeated PRACH for multiple times, then this may implicitly indicate that the same time and frequency resources are used in the adjacent slots for repeated PRACH transmission. In implementations, the UE is explicitly configured with time and frequency resources for repeated PRACH transmission that may or may not be within the same slot of the RO. In implementations, the repetition factor or parameters associated with long PRACH transmission are part of broadcast messages, e.g., SIB1 or SIB19.

Implementations also provide for SRS burst transmission for beam refinement in connected state. For instance, in implementations a UE applies a method for NTN beam refinement in connected mode. The method, for example, is based on a burst of SRS transmissions by the UE using the SSB received spatial filter when the UE detects a new SSB after the initial access procedure has been performed, where the configuration of SRS burst transmission can be indicated to the UE during the initial access procedure. This procedure may be used in NTN when beam hopping is to be used and wider beams can used for common channel signaling and narrow beams can be used for data transmission. The procedure may be summarized as follows:

In a first step, a UE in Idle mode or non-connected state can search for SSBs to perform an initial access procedure. Once SSBs are detected, the UE can perform RACH procedure. Note that SSB beams can have common channel signals and are wider with larger coverage density. The UE and network can perform the initial access procedure by exchanging Msg 1/2/3/4 with the same wider spatial filter. Once the UE has performed initial access procedure, the network can configure the UE with an SRS configuration that is to be used for an SRS burst with multiple SRS transmission using the same received SSB spatial filter upon detection of new SSB, e.g., at least after SSB periodicity duration. For instance, in the first occasion of SSB detection, the UE can perform initial access and receiver SRS configuration, and in the second occasion of SSB detection (e.g., at least after 20 msec of receiving the initializing SSB), the UE can transmit SRS burst (multiple SRS transmission) based on first received configuration using the received SSB spatial filter. The network can monitor the configured SRS reception beams and apply different spatial filters for narrow beams. The network can then select the best spatial filter based on criteria (e.g., RSRP) and transmit the downlink signal on the narrow beam.

In implementations, the SRS configuration (e.g., as part of the RRC signaling IE SRS-Config) is coupled with SSB periodicity, where the SRS configuration includes at least the following parameters: SRS resources; Spatial relation information is only SSB, thus implying that SRS transmission can use the received SSB spatial filter; A repetition factor that can implicitly indicate that the configured SRS resources can be repeated as a burst transmission, and the UL SRS signal is transmitted using the same spatial filter; An indication implying that the SRS configuration is for beam refinement and is coupled with SSB transmission, thus implicitly indicating that for every SSB reception occasion (or beam hopping occasion), the SRS configuration is valid, and an SRS burst transmission is carried out until, unless otherwise indicated by, another parameter to deactivate or invalidate the SRS configuration.

In implementations, the repetition of SRS resources to form a bursty transmission for DL beam refinement is flexible and may be configured on single slot level or across slots, thus the configuration can include an indication whether the repetition of SRS resources is intra-slot or inter-slot. In one example, when the repetition is based on intra-slot, this may implicitly indicate that a

UE can repeat the frequency resources on consecutive symbols within a slot. For instance, if SRS resource mapping contains two symbols and repetition factor is 4, then the UE can repeat the SRS resources consecutively on the next 8 symbols. In one example, if the repetition type is intra-slot, the network can additionally indicate a symbol gap for repetition to compensate for delay at network side for switching different narrow filters. In one example, when the repetition type is inter-slot, then then this may implicitly indicate that the same time and frequency resources are repeated at consecutive slots whereas the number of slots for SRS burst transmission would be equal to the repetition factor. In one example, when a slot offset is configured in SRS configuration, this may imply a repetition of time frequency resources with the slot offset.

In implementations, an aperiodic time duration is coupled with SRS burst transmission configuration. For instance, when an SRS configuration is configured for beam refinement (e.g., either implicitly or through an explicit indication in SRS configuration), and an aperiodic time configuration is also part of SRS configuration, then this may imply that the SRS is triggered after x slots from receiving the SSB in the connected mode. In implementations, a receive filter used to receive DMRS for PDSCH is configured to be equivalent to a transmit filter used to transmit a prior SRS. In one example, the prior SRS corresponds to at least one SRS in the SRS burst.

In implementations, the UE receives a CSI-RS associated with an NZP CSI-RS resource set configured with repetition, where the CSI-RS is based on a received SRS in the SRS burst. In an example, a first receive filter associated with receiving the CSI-RS is correlated with a second received filter used to receive a corresponding prior SSB, where a first receive beamwidth associated with the CSI-RS is smaller than a second receive beamwidth associated with the corresponding prior SSB. In an example, a receive filter associated with receiving the CSI-RS is correlated with a transmit filter used to transmit the received SRS, where a receive beamwidth associated with the CSI-RS is smaller than a transmit beamwidth associated with the SRS.

Implementations described herein also provide a new DCI format for common signal and/or data transmission coordination in NTN deployments. In implementations, a UE is configured with receiving a parameter that identifies whether beam hopping is enabled or disabled. The parameter, for instance, may a part of higher layer configuration signaling (e.g., RRC) or as part of DCI configuration that is used to describe the beam hopping parameters. Beam hopping here, for example, implies grouping of a set of SSBs so that at a given periodicity value, SSBs associated with a first group of SSBs are transmitted at a first SSB transmission occasion, a subsequent group of SSBs is transmitted at a subsequent SSB transmission occasion, and so on. For example, the following provides some examples of the indication of the beam hopping (or beam management) to the UE by the network: In one implementation, the enabling/disabling of beam hopping may be part of DCI signaling via a DCI format dedicated for beam hopping. In another implementation, the UE can receive a separate indication for enabling/disabling of beam hopping using RRC signaling (e.g., as part of broadcast message using SIB (for example in SIB 19 that is used for NTN parameters)), where the UE can receive beam hopping parameters as part of the DCI whose format corresponds to beam hopping. In one example, beam hopping is associated with a distinct RNTI (e.g., configured by higher layer), where the scrambling of the RNTI can indicate that the signal is to be used for NTN beam hopping.

According to such implementations, the UE can be configured with receiving a set of beams according to a plurality of beam groups, where a signaling indicating a subset of beams that the UE is expected to receive can be communicated via DCI signaling according to a format corresponding to beam hopping. Several such example implementations are described below. According to an example, one or more elements or features from one or more of the described implementations may be combined.

Implementations also provide for beam grouping to CSI-RS or SSB resources. In a first implementation, a set of beams comprises a plurality of beam groups, each beam group of the plurality of beam groups includes multiple beams. In a first example, the multiple beams in a beam group correspond to one or more SSB resources, where the one or more SSBs are associated with at least one active beam. In a second example, the UE is configured with multiple CSI-RS resource sets, where the plurality of beam groups corresponds to a plurality of CSI-RS resource sets.

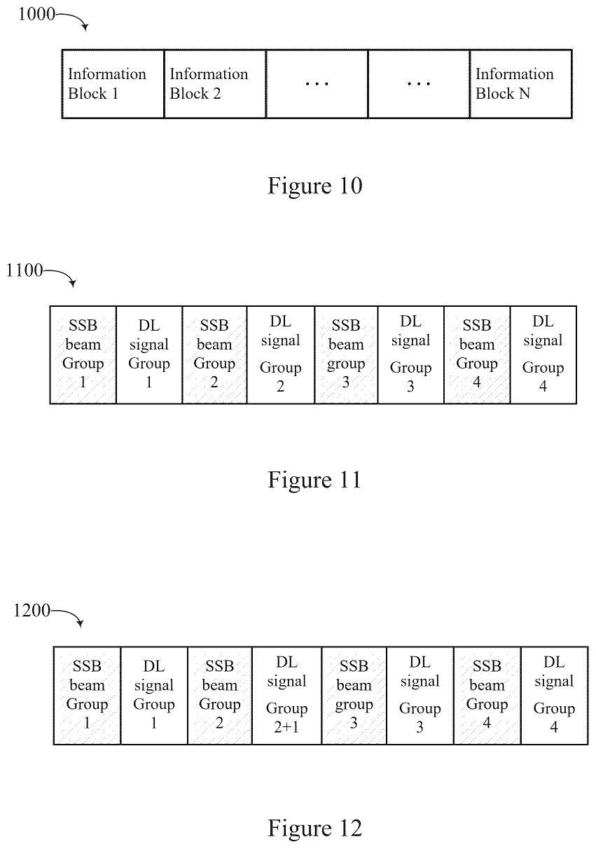

FIG. 10 illustrates an example scenario where individual beams groups are associated with information blocks of a DCI 1000 in accordance with aspects of the present disclosure. In implementations each beam group can be associated with an information block of the DCI 1000. For instance, a UE can be configured with receiving a PDCCH corresponding to a DCI format including at least one information block. In a first example, a number of the information blocks corresponds to a number of beam groups. In a second example, a number of the information blocks is higher-layer configured or included in a SIB message associated with the SSB. In a third example, the UE is associated with one or more indicators of one or more positions of information blocks, where a first indicator of the one or more indicators is associated with SSB signaling, and a remainder of indicators of the one or more indicators are associated with other signaling, e.g., PDSCH signaling. In some examples, the first indicator is additionally associated with other signaling. In a fourth example, the DCI signal is common for a plurality of UEs, where each UE in the plurality of UEs is associated with a subset of the N information blocks.

In implementations, each information block in the at least one information block comprises at least one of: (1) An activation/deactivation parameter that enables at least one of activating and deactivating beam hopping, such that when the parameter is activated, the UE is expected to receive at least one beam in the set of beams according to a beam hopping procedure; (2) An activation/deactivation parameter that enables at least one of activating and deactivating cell DTX corresponding to the UEs associated with the information block; (3) A configuration parameter indicating some properties of an SSB signaling for a corresponding beam group, e.g., SSB positions in either half frame, bitmap corresponding to selected SSB indices, etc.; (4) A reception occasion indication for receiving the common signal, e.g., an indication of a timing at which SSBs corresponding to a given information block is included in the DCI format, e.g., indication is starting from 0) with increments of 20 ms up to T-20, where T is the overall periodicity of all beams over the entire beam groups; (5) A bitmap indicating a set of entries, each entry in the set of entries corresponds to a distinct DL signal, where a value of the entry indicates whether the distinct DL signal is expected to be received during a cell DTX non-active period; (6) An indication on whether a set of common signals are expected to be received during a cell DTX non-active period; (7) An indication on whether a set of dedicated signals are expected to be received during a cell DTX non-active period.

In a first example, the set of common signal comprises at least one of SS/PBCH, TRS, CSI-RS, PDCCH not scrambled with UE-specific RNTI. In a second example, the set of dedicated signals comprises at least one of SPS-PDSCH, and PDCCH scrambled with UE-specific RNTI. In a third example, the distinct DL signal includes at least one signal in the set of common signals and the set of dedicated signals.

In implementations, the UE is in an RRC connected mode prior to receiving the DCI signal. In a first example, the DCI signal indicates to the UE whether a following SSB reception follows a beam hopping scheme according to parameter values included in at least one information block associated with the UE. In a second example, the UE is expected to receive an RRC configuration associated with the DCI signal.

Implementations also support a CORESET pool for DCI received over SIB. For instance, a UE is in an RRC idle mode prior to receiving the DCI signal. In a first example, the UE is configured with a CORESET pool as part of a SIB associated with the SS/PBCH received at the UE, and the UE is expected to receive the DCI signal on at least one control resource set indicated in the CORESET pool. In a second example, the UE is expected to receive the DCI at least after a buffer time associated with receiving the SIB, where the buffer time can be fixed or indicated in the SIB.

Implementations also support two DCIs received for beam hopping and cell DTX. For instance, a UE further receives a second DCI signal corresponding to at least cell DTX. In a first example, a UE is expected to follow a cell DTX configuration in the DCI corresponding to at least the cell DTX, where at least one of a cell DTX active period and a cell DTX non-active period is associated with a period associated with receiving a subset of beams in the set of beams. In a second example, the UE is expected to be in a cell DTX non-active period within or after a duration corresponding to a periodicity value of SS/PBCH from a time at which the subset of beams is received, up until a start time of receiving a subsequent occasion of the subset of beams according to a second periodicity value associated with the subset of beams. In a third example, a mapping of information blocks of the first DCI signal and information blocks of the second DCI signal is based on a one-to-one mapping.

FIG. 11 and FIG. 12 illustrate example timelines of receiving SSB beam groups and corresponding DL signaling in accordance with aspects of the present disclosure. FIG. 11, for instance, illustrates a timeline 1100 of receiving SSB beam groups and corresponding DL signaling associated with each group. FIG. 12 illustrates a timeline 1200 of receiving SSB beam groups and corresponding DL signaling associated with each group with overlapping DL signal groups over at least one time duration. In implementations, a subset of beams is decomposed into four subsets of beams referred to as SSB beam groups, and a UE is associated with one group of the SSB beam groups and at least one group of the DL signal groups. In other implementations, the subset of beams is decomposed into four subset of beams referred to as SSB beam groups, and a UE is associated with one group of the SSB beam groups and at least one group of the DL signal groups.

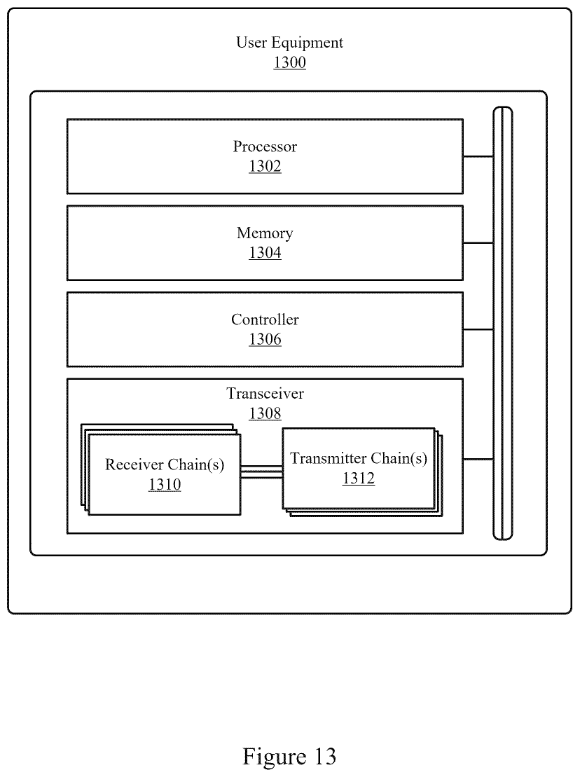

FIG. 13 illustrates an example of a UE 1300 in accordance with aspects of the present disclosure. The UE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the UE 1300 to perform various functions of the present disclosure.

The memory 1304 may include volatile or non-volatile memory. The memory 1304 may store computer-readable, computer-executable code including instructions when executed by the processor 1302 cause the UE 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the UE 1300 to perform one or more of the functions described herein (e.g., executing, by the processor 1302, instructions stored in the memory 1304). For example, the processor 1302 may support wireless communication at the UE 1300 in accordance with examples as disclosed herein. The UE 1300 may be configured to or operable to support a means for receiving a first downlink beam; transmitting at least one uplink signal based at least in part on the first downlink beam; and receiving a second downlink beam based at least in part on the first downlink beam, wherein the second downlink beam includes at least one different spatial domain property than the first downlink beam.

Additionally, the UE 1300 may be configured to support any one or combination of where the at least one uplink signal includes one or more of a PRACH transmission or a SRS transmission; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; further including receiving a configuration for the at least one uplink signal, wherein the configuration includes parameters for performing an extended PRACH transmission by transmitting multiple uplink signals; the parameters include a repetition factor and PRACH duration for determining a duration and resources for the extended PRACH transmission of uplink signals; further including determining the duration for the extended PRACH transmission of uplink signals based at least in part on multiplying the PRACH duration with the repetition factor.

Additionally, the UE 1300 may be configured to support any one or combination of transmitting multiple uplink signals corresponding to the repetition factor using spatial domain properties of the first downlink beam; the extended PRACH transmission includes consecutive time domain symbols of slots that are determined by extending a number of PRACH symbols by the repetition factor; further including: receiving the first downlink beam at a first occasion and perform an initial access procedure based at least in part on the first downlink beam; receiving a SRS configuration for beam refinement; receiving the first downlink beam at a second occasion and transmit a SRS burst based at least in part on the SRS configuration; and receive the second downlink beam based at least in part on the SRS burst; the SRS configuration for beam refinement includes at least a repetition factor defining a length of the SRS burst; further including receiving an indication that the repetition factor is within a slot or across slots; further including receiving an indication to use one or more spatial domain properties of the first downlink beam for multiple SRS repetitions.

Additionally, or alternatively, the UE 1300 may support at least one memory (e.g., the memory 1304) and at least one processor (e.g., the processor 1302) coupled with the at least one memory and configured to cause the UE to receive a first downlink beam; transmit at least one uplink signal based at least in part on the first downlink beam; and receive a second downlink beam based at least in part on the first downlink beam, wherein the second downlink beam includes at least one different spatial domain property than the first downlink beam.

Additionally, the UE 1300 may be configured to support any one or combination of where the at least one uplink signal includes one or more of a PRACH transmission or a SRS transmission; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; the at least one processor is configured to cause the UE to receive a configuration for the at least one uplink signal, wherein the configuration includes parameters for performing an extended PRACH transmission by transmitting multiple uplink signals; the parameters include a repetition factor and PRACH duration for determining a duration and resources for the extended PRACH transmission of uplink signals; the at least one processor is configured to cause the UE to determine the duration for the extended PRACH transmission of uplink signals based at least in part on multiplying the PRACH duration with the repetition factor.

Additionally, the UE 1300 may be configured to support any one or combination of where the at least one processor is configured to cause the UE to transmit multiple uplink signals corresponding to the repetition factor using spatial domain properties of the first downlink beam; the extended PRACH transmission includes consecutive time domain symbols of slots that are determined by extending a number of PRACH symbols by the repetition factor; the at least one processor is configured to cause the UE to: receive the first downlink beam at a first occasion and perform an initial access procedure based at least in part on the first downlink beam; receive a SRS configuration for beam refinement; receive the first downlink beam at a second occasion and transmit a SRS burst based at least in part on the SRS configuration; and receive the second downlink beam based at least in part on the SRS burst; the SRS configuration for beam refinement includes at least a repetition factor defining a length of the SRS burst; the at least one processor is configured to cause the UE to receive an indication that the repetition factor is within a slot or across slots; the at least one processor is configured to cause the UE to receive an indication to use one or more spatial domain properties of the first downlink beam for multiple SRS repetitions.

The controller 1306 may manage input and output signals for the UE 1300. The controller 1306 may also manage peripherals not integrated into the UE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the UE 1300 may include at least one transceiver 1308. In some other implementations, the UE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

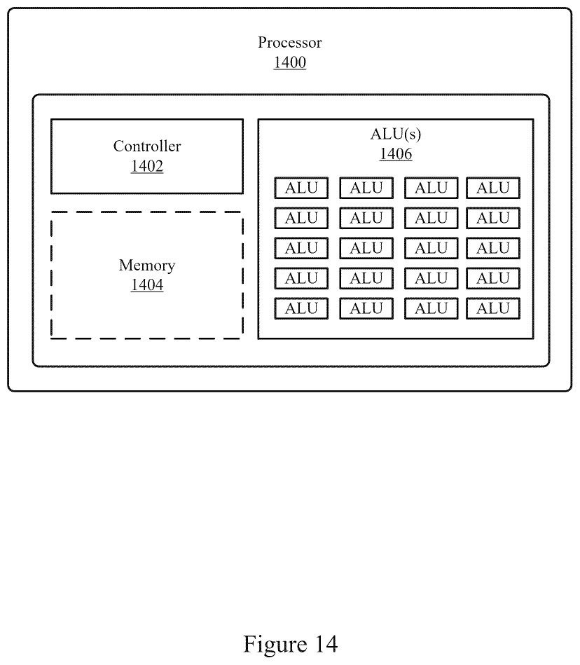

FIG. 14 illustrates an example of a processor 1400 in accordance with aspects of the present disclosure. The processor 1400 may be an example of a processor configured to perform various operations in accordance with examples as described herein. The processor 1400 may include a controller 1402 configured to perform various operations in accordance with examples as described herein. The processor 1400 may optionally include at least one memory 1404, which may be, for example, an L1/L2/L3 cache. Additionally, or alternatively, the processor 1400 may optionally include one or more arithmetic-logic units (ALUs) 1406. One or more of these components may be in electronic communication or otherwise coupled (e.g., operatively, communicatively, functionally, electronically, electrically) via one or more interfaces (e.g., buses).

The processor 1400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1402 may be configured to manage and coordinate various operations (e.g., signaling, receiving, obtaining, retrieving, transmitting, outputting, forwarding, storing, determining, identifying, accessing, writing, reading) of the processor 1400 to cause the processor 1400 to support various operations in accordance with examples as described herein. For example, the controller 1402 may operate as a control unit of the processor 1400, generating control signals that manage the operation of various components of the processor 1400. These control signals include enabling or disabling functional units, selecting data paths, initiating memory access, and coordinating timing of operations.

The controller 1402 may be configured to fetch (e.g., obtain, retrieve, receive) instructions from the memory 1404 and determine subsequent instruction(s) to be executed to cause the processor 1400 to support various operations in accordance with examples as described herein. The controller 1402 may be configured to track memory addresses of instructions associated with the memory 1404. The controller 1402 may be configured to decode instructions to determine the operation to be performed and the operands involved. For example, the controller 1402 may be configured to interpret the instruction and determine control signals to be output to other components of the processor 1400 to cause the processor 1400 to support various operations in accordance with examples as described herein. Additionally, or alternatively, the controller 1402 may be configured to manage flow of data within the processor 1400. The controller 1402 may be configured to control transfer of data between registers, ALUs 1406, and other functional units of the processor 1400.

The memory 1404 may include one or more caches (e.g., memory local to or included in the processor 1400 or other memory, such as RAM, ROM, DRAM, SDRAM, SRAM, MRAM, flash memory, etc. In some implementations, the memory 1404 may reside within or on a processor chipset (e.g., local to the processor 1400). In some other implementations, the memory 1404 may reside external to the processor chipset (e.g., remote to the processor 1400).

The memory 1404 may store computer-readable, computer-executable code including instructions that, when executed by the processor 1400, cause the processor 1400 to perform various functions described herein. The code may be stored in a non-transitory computer-readable medium such as system memory or another type of memory. The controller 1402 and/or the processor 1400 may be configured to execute computer-readable instructions stored in the memory 1404 to cause the processor 1400 to perform various functions. For example, the processor 1400 and/or the controller 1402 may be coupled with or to the memory 1404, the processor 1400, and the controller 1402, and may be configured to perform various functions described herein. In some examples, the processor 1400 may include multiple processors and the memory 1404 may include multiple memories. One or more of the multiple processors may be coupled with one or more of the multiple memories, which may, individually or collectively, be configured to perform various functions herein.

The one or more ALUs 1406 may be configured to support various operations in accordance with examples as described herein. In some implementations, the one or more ALUs 1406 may reside within or on a processor chipset (e.g., the processor 1400). In some other implementations, the one or more ALUs 1406 may reside external to the processor chipset (e.g., the processor 1400). One or more ALUs 1406 may perform one or more computations such as addition, subtraction, multiplication, and division on data. For example, one or more ALUs 1406 may receive input operands and an operation code, which determines an operation to be executed. One or more ALUs 1406 may be configured with a variety of logical and arithmetic circuits, including adders, subtractors, shifters, and logic gates, to process and manipulate the data according to the operation. Additionally, or alternatively, the one or more ALUs 1406 may support logical operations such as AND, OR, exclusive-OR (XOR), not-OR (NOR), and not-AND (NAND), enabling the one or more ALUs 1406 to handle conditional operations, comparisons, and bitwise operations.

The processor 1400 may support wireless communication in accordance with examples as disclosed herein. The processor 1400 may be configured to or operable to support at least one controller (e.g., the controller 1402) coupled with at least one memory (e.g., the memory 1404) and configured to cause the processor to receive a first downlink beam; transmit at least one uplink signal based at least in part on the first downlink beam; and receive a second downlink beam based at least in part on the first downlink beam, wherein the second downlink beam includes at least one different spatial domain property than the first downlink beam.

Additionally, the processor 1400 may be configured to or operable to support any one or combination of where the at least one uplink signal includes one or more of a PRACH transmission or a SRS transmission; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; the at least one controller is configured to cause the processor to receive a configuration for the at least one uplink signal, wherein the configuration includes parameters for performing an extended PRACH transmission by transmitting multiple uplink signals; the parameters include a repetition factor and PRACH duration for determining a duration and resources for the extended PRACH transmission of uplink signals; the at least one controller is configured to cause the processor to determine the duration for the extended PRACH transmission of uplink signals based at least in part on multiplying the PRACH duration with the repetition factor.

Additionally, the processor 1400 may be configured to or operable to support any one or combination of where the at least one controller is configured to cause the processor to transmit multiple uplink signals corresponding to the repetition factor using spatial domain properties of the first downlink beam; the extended PRACH transmission includes consecutive time domain symbols of slots that are determined by extending a number of PRACH symbols by the repetition factor; receive the first downlink beam at a first occasion and perform an initial access procedure based at least in part on the first downlink beam; receive a SRS configuration for beam refinement; receive the first downlink beam at a second occasion and transmit a SRS burst based at least in part on the SRS configuration; and receive the second downlink beam based at least in part on the SRS burst; the SRS configuration for beam refinement includes at least a repetition factor defining a length of the SRS burst; the at least one controller is configured to cause the processor to receive an indication that the repetition factor is within a slot or across slots; the at least one controller is configured to cause the processor to receive an indication to use one or more spatial domain properties of the first downlink beam for multiple SRS repetitions.

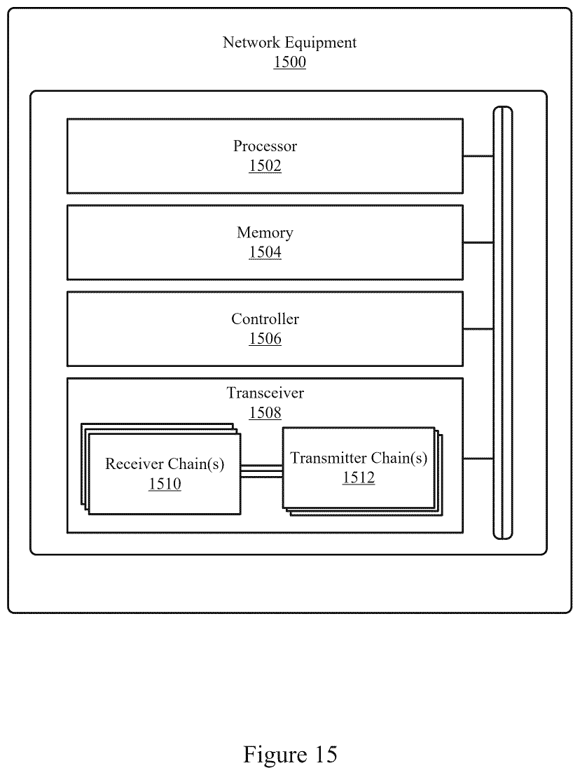

FIG. 15 illustrates an example of a NE 1500 in accordance with aspects of the present disclosure. The NE 1500 may include a processor 1502, a memory 1504, a controller 1506, and a transceiver 1508. The processor 1502, the memory 1504, the controller 1506, or the transceiver 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the controller 1506, or the transceiver 1508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the NE 1500 to perform various functions of the present disclosure.

The memory 1504 may include volatile or non-volatile memory. The memory 1504 may store computer-readable, computer-executable code including instructions when executed by the processor 1502 cause the NE 1500 to perform various functions described herein. The code may be stored in a non-transitory computer-readable medium such as the memory 1504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1502 and the memory 1504 coupled with the processor 1502 may be configured to cause the NE 1500 to perform one or more of the functions described herein (e.g., executing, by the processor 1502, instructions stored in the memory 1504). For example, the processor 1502 may support wireless communication at the NE 1500 in accordance with examples as disclosed herein. The NE 1500 may be configured to or operable to support a means for transmitting a first downlink beam; receiving at least one uplink signal based at least in part on the first downlink beam; and transmitting a second downlink beam based at least in part on the first downlink beam, wherein the second downlink beam includes at least one different spatial domain property than the first downlink beam.

Additionally, the NE 1500 may be configured to or operable to support any one or combination of where the at least one uplink signal includes one or more of a PRACH transmission or a SRS transmission; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; transmitting a configuration for the at least one uplink signal, wherein the configuration includes parameters for performing an extended PRACH transmission by transmitting multiple uplink signals.

Additionally, or alternatively, the NE 1500 may support at least one memory (e.g., the memory 1504) and at least one processor (e.g., the processor 1502) coupled with the at least one memory and configured to cause the NE to transmit a first downlink beam; receive at least one uplink signal based at least in part on the first downlink beam; and transmit a second downlink beam based at least in part on the first downlink beam, wherein the second downlink beam includes at least one different spatial domain property than the first downlink beam.

Additionally, the NE 1500 may be configured to support any one or combination of where the at least one uplink signal includes one or more of a PRACH transmission or a SRS transmission; the second downlink beam includes one or more of DMRS for PDSCH, TRS, or CSI-RS; one or more of a coverage area, a beam width, or a beam footprint associated with the first downlink beam is larger than one or more of a coverage area, a beam width, or a beam footprint associated with the second downlink beam; the at least one processor is configured to cause the NE to transmit a configuration for the at least one uplink signal, wherein the configuration includes parameters for performing an extended PRACH transmission by transmitting multiple uplink signals.

The controller 1506 may manage input and output signals for the NE 1500. The controller 1506 may also manage peripherals not integrated into the NE 1500. In some implementations, the controller 1506 may utilize an operating system such as iOS®, ANDROID®, WINDOWS®, or other operating systems. In some implementations, the controller 1506 may be implemented as part of the processor 1502.

In some implementations, the NE 1500 may include at least one transceiver 1508. In some other implementations, the NE 1500 may have more than one transceiver 1508. The transceiver 1508 may represent a wireless transceiver. The transceiver 1508 may include one or more receiver chains 1510, one or more transmitter chains 1512, or a combination thereof.

A receiver chain 1510 may be configured to receive signals (e.g., control information, data, packets) over a wireless medium. For example, the receiver chain 1510 may include one or more antennas to receive a signal over the air or wireless medium. The receiver chain 1510 may include at least one amplifier (e.g., a low-noise amplifier (LNA)) configured to amplify the received signal. The receiver chain 1510 may include at least one demodulator configured to demodulate the receive signal and obtain the transmitted data by reversing the modulation technique applied during transmission of the signal. The receiver chain 1510 may include at least one decoder for decoding the demodulated signal to receive the transmitted data.

A transmitter chain 1512 may be configured to generate and transmit signals (e.g., control information, data, packets). The transmitter chain 1512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1512 may also include at least one power amplifier configured to amplify the modulated signal to an appropriate power level suitable for transmission over the wireless medium. The transmitter chain 1512 may also include one or more antennas for transmitting the amplified signal into the air or wireless medium.

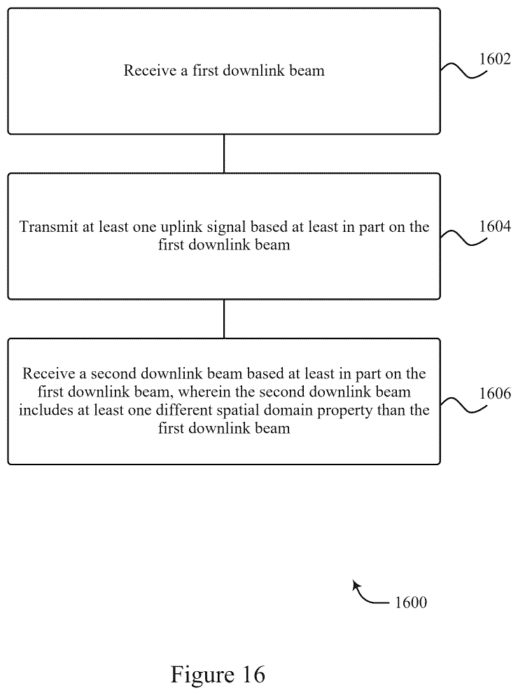

FIG. 16 illustrates a flowchart of a method 1600 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1602, the method may include receiving a first downlink beam. The operations of 1602 may be performed in accordance with examples as described herein. In some implementations, aspects of the operations of 1602 may be performed by a UE as described with reference to FIG. 13.

At 1604, the method may include transmitting at least one uplink signal based at least in part on the first downlink beam. The operations of 1604 may be performed in accordance with examples as described herein. In some implementations, aspects of the operations of 1604 may be performed by a UE as described with reference to FIG. 13.

At 1606, the method may include receiving a second downlink beam based at least in part on the first downlink beam, wherein the second downlink beam includes at least one different spatial domain property than the first downlink beam. The operations of 1606 may be performed in accordance with examples as described herein. In some implementations, aspects of the operations of 1606 may be performed by a UE as described with reference to FIG. 13.

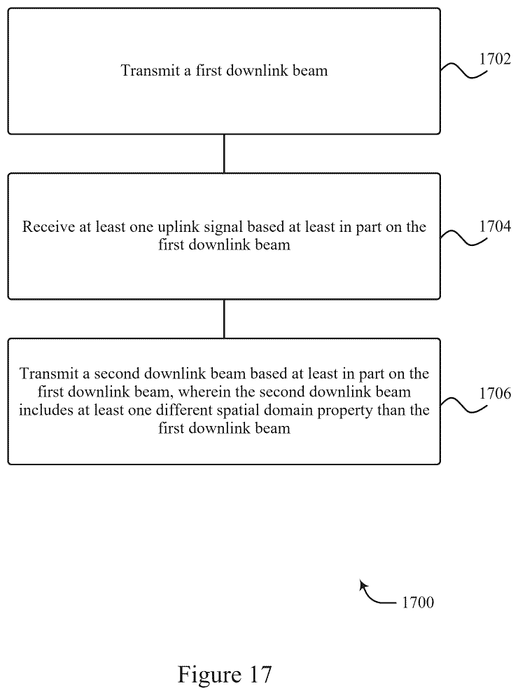

FIG. 17 illustrates a flowchart of a method 1700 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1702, the method may include transmitting a first downlink beam. The operations of 1702 may be performed in accordance with examples as described herein. In some implementations, aspects of the operations of 1702 may be performed by a NE as described with reference to FIG. 15.

At 1704, the method may include receive at least one uplink signal based at least in part on the first downlink beam. The operations of 1704 may be performed in accordance with examples as described herein. In some implementations, aspects of the operations of 1704 may be performed by a NE as described with reference to FIG. 15.

At 1706, the method may include transmitting a second downlink beam based at least in part on the first downlink beam, wherein the second downlink beam includes at least one different spatial domain property than the first downlink beam. The operations of 1706 may be performed in accordance with examples as described herein. In some implementations, aspects of the operations of 1706 may be performed by a NE as described with reference to FIG. 15.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a first downlink beam;
transmit at least one uplink signal based at least in part on the first downlink beam; and
receive a second downlink beam based at least in part on the first downlink beam, wherein the second downlink beam comprises at least one different spatial domain property than the first downlink beam.

2. The UE of claim 1, wherein the at least one uplink signal includes one or more of a physical random access channel (PRACH) transmission or a sounding reference signal (SRS) transmission.

3. The UE of claim 1, wherein the second downlink beam includes one or more of demodulation reference signal (DMRS) for physical downlink shared channel (PDSCH), tracking reference signal (TRS), or channel state information reference signal (CSI-RS).

4. The UE of claim 1, wherein one or more of a coverage area, a beam width, or a beam footprint associated with the first downlink beam is larger than one or more of a coverage area, a beam width, or a beam footprint associated with the second downlink beam.

5. The UE of claim 1, wherein the at least one processor is configured to cause the UE to receive a configuration for the at least one uplink signal, wherein the configuration comprises parameters for performing an extended physical random access channel (PRACH) transmission by transmitting multiple uplink signals.

6. The UE of claim 5, wherein the parameters comprise a repetition factor and PRACH duration for determining a duration and resources for the extended PRACH transmission of uplink signals.

7. The UE of claim 6, wherein the at least one processor is configured to cause the UE to determine the duration for the extended PRACH transmission of uplink signals based at least in part on multiplying the PRACH duration with the repetition factor.

8. The UE of claim 6, wherein the at least one processor is configured to cause the UE to transmit multiple uplink signals corresponding to the repetition factor using spatial domain properties of the first downlink beam.

9. The UE of claim 6, wherein the extended PRACH transmission comprises consecutive time domain symbols of slots that are determined by extending a number of PRACH symbols by the repetition factor.

10. The UE of claim 1, wherein the at least one processor is configured to cause the UE to:
receive the first downlink beam at a first occasion and perform an initial access procedure based at least in part on the first downlink beam;
receive a sounding reference signal (SRS) configuration for beam refinement;
receive the first downlink beam at a second occasion and transmit a sounding reference signal (SRS) burst based at least in part on the SRS configuration; and
receive the second downlink beam based at least in part on the SRS burst.

11. The UE of claim 10, wherein the SRS configuration for beam refinement comprises at least a repetition factor defining a length of the SRS burst.

12. The UE of claim 11, wherein the at least one processor is configured to cause the UE to receive an indication that the repetition factor is within a slot or across slots.

13. The UE of claim 11, wherein the at least one processor is configured to cause the UE to receive an indication to use one or more spatial domain properties of the first downlink beam for multiple SRS repetitions.

14. A processor for wireless communication, comprising:
at least one controller coupled with at least one memory and configured to cause the processor to:
receive a first downlink beam;
transmit at least one uplink signal based at least in part on the first downlink beam; and
receive a second downlink beam based at least in part on the first downlink beam, wherein the second downlink beam comprises at least one different spatial domain property than the first downlink beam.

15. A method performed by a user equipment (UE), the method comprising:
receiving a first downlink beam;
transmitting at least one uplink signal based at least in part on the first downlink beam; and
receiving a second downlink beam based at least in part on the first downlink beam, wherein the second downlink beam comprises at least one different spatial domain property than the first downlink beam.

16. A network equipment for wireless communication, comprising:
at least one memory; and
at least one processor coupled with the at least one memory and configured to cause the network equipment to:
transmit a first downlink beam;
receive at least one uplink signal based at least in part on the first downlink beam; and
transmit a second downlink beam based at least in part on the first downlink beam, wherein the second downlink beam comprises at least one different spatial domain property than the first downlink beam.

17. The network equipment of claim 16, wherein the at least one uplink signal includes one or more of a physical random access channel (PRACH) transmission or a sounding reference signal (SRS) transmission.

18. The network equipment of claim 16, wherein the second downlink beam includes one or more of demodulation reference signal (DMRS) for physical downlink shared channel (PDSCH), tracking reference signal (TRS), or channel state information reference signal (CSI-RS).

19. The network equipment of claim 16, wherein one or more of a coverage area, a beam width, or a beam footprint associated with the first downlink beam is larger than one or more of a coverage area, a beam width, or a beam footprint associated with the second downlink beam.

20. The network equipment of claim 16, wherein the at least one processor is configured to cause the network equipment to transmit a configuration for the at least one uplink signal, wherein the configuration comprises parameters for performing an extended physical random access channel (PRACH) transmission by transmitting multiple uplink signals.
